(19) United States
(12) Patent Application Publication
(10) Pub. No.: US 2020/0082035 A1
(43) Pub. Date: Mar. 12, 2020

(54) SIMULATION METHOD, PHYSICAL QUANTITY CALCULATION PROGRAM, AND PHYSICAL QUANTITY CALCULATION APPARATUS

(71) Applicant: AGC Inc., Chiyoda-ku (JP)

(72) Inventor: Tsunehiro SAITO, Chiyoda-ku (JP)

(73) Assignee: AGC Inc., Chiyoda-ku (JP)

(21) Appl. No.: 16/285,261

(22) Filed: Feb. 26, 2019

Related U.S. Application Data
(63) Continuation of application No. PCT/JP2018/043836, filed on Nov. 28, 2018.

(30) Foreign Application Priority Data
Sep. 12, 2018 (JP) 2018-170766

(51) Int. Cl. G06F 17/50; G06F 17/16

(52) U.S. Cl. CPC G06F 17/5009; G06F 2217/16; G06F 17/16

(57) ABSTRACT

A simulation method executed by a computer includes: dividing an analysis domain into multiple divided domains; generating a calculation data model with respect to the divided domains that includes the volume of each divided domain and a divided-domain characteristic quantity representing a characteristic quantity of the divided domain with respect to each adjacent domain as the quantities that do not require the vertices and connectivity; generating a requested number of aggregated domains by aggregating the multiple divided domains; generating a calculation data model with respect to the aggregated domains that includes the volume of each of the aggregated domains and an aggregated-domain characteristic quantity representing a characteristic quantity of the aggregated domain with respect to each adjacent domain as the quantities that do not require the vertices and connectivity; and calculating a physical quantity as an analysis result with respect to the aggregated domains.

### CROSS-REFERENCE TO RELATED APPLICATIONS

This U.S. non-provisional application is a continuation application of, and claims the benefit of priority under 35 U.S.C. § 365(c) from, PCT International Application PCT/JP2018/043836 filed on Nov. 28, 2018, which is designated the U.S., and is based upon and claims the benefit of priority of Japanese Patent Application No. 2018-170766 filed on Sep. 12, 2018, the entire contents both of which are incorporated herein by reference.

### TECHNICAL FIELD

The present invention relates to a simulation method, a physical quantity calculation program, and a physical quantity calculation apparatus.

### BACKGROUND ART

Conventionally, as numerical analysis methods for obtaining flow velocity distribution, stress distribution, temperature distribution, and the like by numerical analysis, for example, the finite element method, the finite volume method, the voxel method, and the particle method have been known.

However, as has been very well known, when attempting to obtain a sufficient analysis precision, such conventional numerical analysis methods have a problem in that a huge amount of work and time is required for generation of a calculation data model and for a solver process.

In order to solve such a problem, a method of numerical analysis was proposed in Patent document 1. The method in Patent document 1 does not need a mesh, which has been indispensable in the conventional numerical analysis methods. Also, the method of Patent document 1 can numerically analyze a physical phenomenon while satisfying the conservation law of a physical quantity in the physical phenomenon to be analyzed. Furthermore, the method of Patent document 1 can reduce the work and time required for generation of a calculation data model while obtaining a sufficient analysis precision.

According to the method of Patent document 1, it can be expected that while maintaining a sufficient analysis precision and reduction of work required for generation of a calculation data model, the time required for a solver process can be further reduced.

### PRIOR ART DOCUMENTS

### Patent Documents

Patent Document 1: WO2010/150758

### SUMMARY

According to one aspect of the present invention, a simulation method executed by a computer to numerically analyze a physical quantity in a physical phenomenon, includes: obtaining by the computer three-dimensional shape data of an analysis domain from an external device; dividing the analysis domain into a plurality of divided domains; generating a calculation data model with respect to the divided domains based on a discretized governing equation with respect to the divided domains that uses only quantities that do not require coordinates of vertices of the divided domains and connectivity information on the vertices, wherein the discretized governing equation is derived based on a weighted residual method, and the calculation data model includes a volume of each divided domain and a divided-domain characteristic quantity representing a characteristic quantity of said each divided domain with respect to each adjacent divided domain as the quantities that do not require the coordinates of the vertices of the divided domains and the connectivity information on the vertices; generating a requested number of aggregated domains by aggregating the divided domains; generating a calculation data model with respect to the aggregated domains based on a discretized governing equation with respect to the aggregated domains that uses only quantities that do not require coordinates of vertices of the aggregated domains and connectivity information on the vertices, wherein the discretized governing equation is derived based on a weighted residual method, and the calculation data model includes a volume of each aggregated domain and an aggregated-domain characteristic quantity representing a characteristic quantity of said each aggregated domain with respect to each adjacent aggregated domain as the quantities that do not require the coordinates of the vertices of the aggregated domains and the connectivity information on the vertices; calculating the physical quantity as an analysis result with respect to the aggregated domains, based on a physical property in the analysis domain and the calculation data model with respect to the aggregated domains; generating visualized data of the physical quantity as the analysis result; and displaying the visualized data on an output device.

### BRIEF DESCRIPTION OF THE DRAWINGS

FIG. 1 is a conceptual diagram illustrating an example of a first calculation data model of the present numerical analysis method.

FIG. 2 is a diagram illustrating an example of a process of generating aggregated domains in a numerical analysis method of the present embodiment;

FIG. 3 is a diagram illustrating an example of a process of generating aggregated domains in a numerical analysis method of the present embodiment;

FIG. 4 is a diagram illustrating an example of a process of generating aggregated domains in a numerical analysis method of the present embodiment;

FIG. 5 is a diagram illustrating an example of a process of generating aggregated domains in a numerical analysis method of the present embodiment;

FIG. 6 is a diagram illustrating an example of a process of generating aggregated domains in a numerical analysis method of the present embodiment;

FIG. 7 is a diagram for describing an example (first example) of an aggregation method of cells in a numerical analysis method of the present embodiment;

FIG. 8 is a diagram for describing an example (second example) of the aggregation method of cells in a numerical analysis method of the present embodiment;

FIG. 9 is a diagram illustrating an example of a boundary-surface characteristic quantity of an aggregated domain in a numerical analysis method of the present embodiment;

FIG. 10 is a diagram illustrating an example of a boundary-surface characteristic quantity of an aggregated domain in a numerical analysis method of the present embodiment;

FIG. 11 is a diagram for describing an example of a boundary-surface characteristic quantity of an aggregated domain on a boundary of an analysis domain in a numerical analysis method of the present embodiment;

FIG. 12 is a diagram for describing an example of a boundary-surface characteristic quantity of an aggregated domain on a boundary of an analysis domain in a numerical analysis method of the present embodiment;

FIG. 13 is a schematic view illustrating an infinitely large projection plane that passes through a control point of a divided domain, and has a unit normal vector directed in an arbitrary direction;

FIG. 14 is a schematic view illustrating a condition required for satisfying the conservation law of a physical quantity in the case of considering a control volume of a spherical divided domain;

FIG. 15 is a schematic view illustrating an infinitely large projection plane that passes through a control point of an aggregated domain, and has a unit normal vector directed in an arbitrary direction;

FIG. 16 is a schematic view illustrating a condition required for satisfying the conservation law of a physical quantity in the case of considering a control volume of a spherical aggregated domain;

FIG. 17 is a block diagram schematically illustrating a hardware configuration of a numerical analysis apparatus in the present embodiment;

FIG. 18 is a flowchart illustrating a numerical analysis method in the present embodiment;

FIG. 19 is a flowchart illustrating a preprocess executed in a numerical analysis method in the present embodiment;

FIG. 20 is a flowchart illustrating a solver process executed in a numerical analysis method in the present embodiment;

FIG. 21 is a flowchart illustrating a numerical analysis method in the case where an analysis domain of the present embodiment includes a moving boundary;

FIG. 22 is a diagram illustrating an example of a result of a thermal fluid simulation with respect to divided domains of the present embodiment;

FIG. 23 is a diagram illustrating an example of a result of a thermal fluid simulation with respect to divided domains of the present embodiment;

FIG. 24 is a diagram illustrating an example of a result of a thermal fluid simulation with respect to divided domains of the present embodiment;

FIG. 25 is a diagram illustrating an example of a generation result of an aggregated domain (domain 1) in a thermal fluid simulation of the present embodiment;

FIG. 26 is a diagram illustrating an example of a generation result of an aggregated domain (domain 2) in a thermal fluid simulation of the present embodiment;

FIG. 27 is a diagram illustrating an example of a generation result of an aggregated domain (domain 3) in a thermal fluid simulation of the present embodiment;

FIG. 28 is a diagram illustrating an example of a generation result of an aggregated domain (domain 4) in a thermal fluid simulation of the present embodiment;

FIG. 29 is a diagram illustrating an example of a generation result of an aggregated domain (domain 5) in a thermal fluid simulation of the present embodiment;

FIG. 30 is a diagram illustrating an example of a generation result of an aggregated domain (domain 6) in a thermal fluid simulation of the present embodiment;

FIG. 31 is a diagram illustrating an example of a result of a thermal fluid simulation (air temperatures) with respect to aggregated domains of the present embodiment;

FIG. 32 is a diagram illustrating an example of a result of a thermal fluid simulation (flow velocity vectors) with respect to aggregated domains of the present embodiment;

FIG. 33 is a diagram illustrating an example of a result of a thermal fluid simulation (air temperatures) with respect to aggregated domains of the present embodiment;

FIG. 34 is a diagram illustrating an example of a result of a thermal fluid simulation (flow velocity vectors) with respect to aggregated domains of the present embodiment;

FIG. 35 is a diagram illustrating an example of a result of a thermal fluid simulation (air temperatures) with respect to aggregated domains of the present embodiment;

FIG. 36 is a diagram illustrating an example of a result of a thermal fluid simulation (flow velocity vectors) with respect to aggregated domains of the present embodiment;

FIG. 37 is a diagram illustrating an example of a result of a thermal fluid simulation (air temperatures) with respect to aggregated domains of the present embodiment; and

FIG. 38 is a diagram illustrating an example of a result of a thermal fluid simulation (flow velocity vectors) with respect to aggregated domains of the present embodiment.

### EMBODIMENTS FOR IMPLEMENTING THE INVENTION

In the following, with reference to drawings, simulation methods, physical quantity calculation programs, and physical quantity calculation apparatuses will be described according to the present invention.

Embodiments in this disclosure provide techniques that can reduce the time required for a solver process in a numerical analysis that numerically analyzes a physical phenomenon.

The embodiments described below are merely examples; and an embodiment to which the present invention is applied is not limited to the following embodiments.

Note that throughout all the drawings for describing the embodiments, the same code will be used for elements having the same function, and repeated description will be omitted.

A “physical phenomenon” in the present embodiment means a phenomenon that is reproducible in a simulation. For example, in the case of a simulation related to a cabin of a motor vehicle, a phenomenon of heat transfer may be considered, which may be caused by insolation by the sun transmitting a window glass; heat taken from the outside surface of a window glass depending on the vehicle speed; blowing air caused by air-conditioning; thermal convection and thermal radiation in the cabin; and the like.

A “physical quantity” in the present embodiment means a quantity obtained as an analysis result of a simulation of a physical phenomenon, such as temperature, thermal flux, stress, pressure, flow velocity, or the like.

An “analysis domain” in the present embodiment means a target domain of an analysis model set for simulating a physical phenomenon. For example, in the case of a cabin of a motor vehicle, the analysis domain corresponds to a cabin space enclosed with objects such as the body, window glasses, and the like of the motor vehicle.

(Outline)

First, an outline of a method of reducing the calculation load in a solver process without decreasing the analysis precision will be described according to the present embodiment.

In general, in a numerical analysis method, the calculation load in a solver process becomes lighter if the sizes of divided domains are set to be larger. Setting the sizes of divided domains to be larger means decreasing the number of divisions of the analysis domain. For this reason, the calculation load in a solver process becomes lighter if the sizes of divided domains are set to be larger. Therefore, this can be rephrased that the calculation load in a solver process can be reduced by decreasing the number of divisions of an analysis domain. However, reducing the number of divisions decreases the analysis precision.

In the present embodiment, executing a preprocess as described below enables to make a reduced calculation load in a solver process thanks to a reduced number of divisions of an analysis domain, compatible with prevention of a decreased analysis precision due to the reduced number of divisions of the analysis domain.

In a preprocess in the present embodiment, in order to reduce the number of divisions of an analysis domain, first, a calculation data model with respect to divided domains (referred to as a “first calculation data model”, below) is generated, which is characterized by quantities that do not require coordinates of vertices of divided domains and connectivity information on the vertices. Next, aggregated domains are formed by aggregating the multiple divided domains to generate a calculation data model with respect to the aggregated domains (referred to as a “second calculation data model”, below). The aggregated domain is also characterized by quantities that do not require coordinates of vertices of the aggregate domains and connectivity information on the vertices. In the present embodiment, since divided domains for generating aggregated domains are characterized by quantities that do not require coordinates of vertices and connectivity information on the vertices, the calculation load in a solver process is reduced as will be described later. Furthermore, as will be described later, in a process of the present embodiment, since analysis is executed with respect to aggregated domains in each of which multiple divided domains are aggregated, unlike the conventional numerical analysis methods, it is possible to make a reduced calculation load in the solver process thanks to a reduced number of divisions of the analysis domain, compatible with prevention of a decreased analysis precision due to the reduced number of divisions of the analysis domain; this further enables to execute the analysis faster.

(Principle)

In the following, the compatibility between a reduced calculation load and prevention of a decreased analysis precision will be described in detail according to the present embodiment.

Unlike conventional methods, a discretized governing equation used in the present embodiment is not expressed in a form that includes coordinates of vertices and connectivity information on the vertices as quantities that specify geometrical shapes of divided domains; namely, the equation does not require coordinates of vertices and connectivity information on the vertices as quantities that specify geometrical shapes of divided domains. In the present embodiment, hereinafter, coordinates of vertices and connectivity information on the vertices as quantities that specify geometrical shapes may be simply referred to as “quantities that specify geometrical shapes”. Furthermore, the discretized governing equation used in the present embodiment does not require even quantities that specify geometrical shapes of aggregated domains formed by aggregating multiple divided domains. The discretized governing equation used in the present embodiment can be obtained by forcibly stopping halfway through a process of deriving a conventional equation that uses quantities specifying geometrical shapes, based on a weighted residual method. The discretized governing equation as such used in the present embodiment is expressed with quantities that do not require geometric shapes of divided domains and aggregated domains; and the equation can be expressed in a form depending on only two types of quantities, for example, a volume and a boundary-surface characteristic quantity of each divided domain. Also, the discretized governing equation used in the present embodiment can also be expressed in a form depending on only two types of quantities, for example, the volume and a boundary-surface characteristic quantity of each aggregated domain.

In other words, in the conventional finite element method and finite volume method, as a prerequisite, an object to be analyzed is divided into minute domains; therefore, a discretized governing equation is derived on the assumption that the quantities specifying the geometrical shapes of the minute domains are used. However, the discretized governing equation used in the present embodiment is derived based on an idea which is different from these conventional methods.

Further, the present embodiment is characterized by using a discretized governing equation derived based on this idea, and unlike the conventional numerical analysis methods, is not dependent on quantities that specify geometrical shapes. Moreover, the present embodiment brings various remarkable effects such as reduction of the computation time and the like, by enabling calculation with respect to aggregated domains formed by aggregating divided domains, which has been neither disclosed nor implied in Patent document 1.

Here, the volume and a boundary-surface characteristic quantity of a divided domain and an aggregated domain are quantities that do not require quantities that specify geometrical shapes of the divided domains, will be described. Note that the quantities that do not require quantities that specify geometrical shapes are quantities that can be defined without using vertices and connectivity.

For example, considering the volume of a divided domain, there exist multiple geometric shapes of the divided domain for the volume to have a certain specific value. In other words, the geometric shape of the divided domain whose volume takes the specific value could be a cube, a sphere, or the like. Then, for example, the volume of the divided domain can be defined by an optimization calculation such that the volume of the divided domain is proportional to the cube of the average distance with respect to adjacent divided domains as much as possible, under a constraint condition that the total sum of all the divided domains is equivalent to the volume of the entire analysis domain. Therefore, the volume of the divided domain can be regarded as a quantity that does not require a specific geometric shape of the divided domain.

Such a characteristic with respect to the volume of a divided domain similarly exists with respect to the volume of an aggregated domain. For this reason, the volume of an aggregated domain can be regarded as a quantity that does not require a specific geometric shape of the aggregated domain.

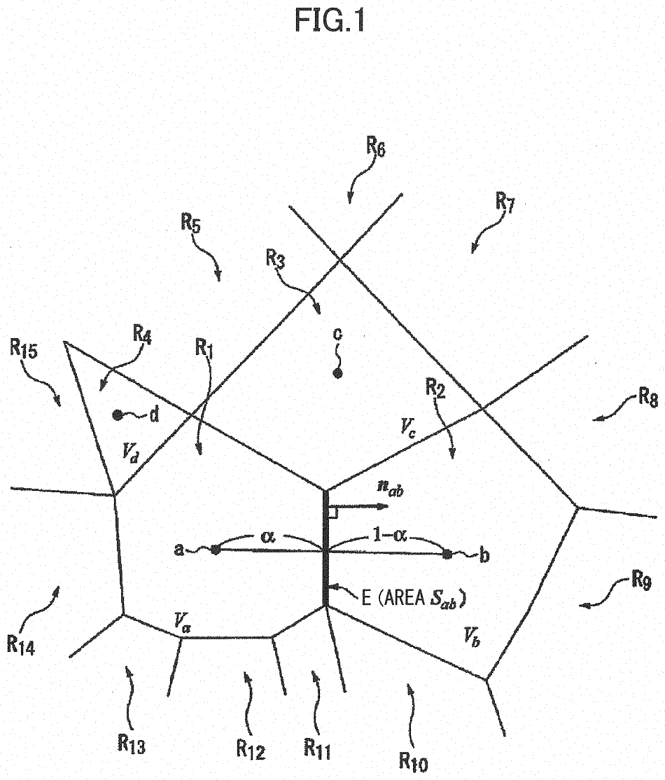

Also, as a boundary-surface characteristic quantity of a divided domain, for example, the area of the boundary surface, the normal vector of the boundary surface, the perimeter of the boundary surface, and the like can be considered; and there exist multiple geometric shapes of the divided domain for these boundary-surface characteristic quantities of the divided domain to have a certain specific value. Then, the boundary-surface characteristic quantity of a divided domain can be defined, for example, by an optimization calculation such that, under a constraint condition that the length of the area-weighted average vector of normal vectors with respect to all the boundary surfaces delimiting the divided domain is zero, the direction of the normal vector of each boundary surface is brought closer to the line segment that connects the control point of the divided domain and the control point of the adjacent divided domain (see FIG. 1), and that the total sum of the areas of all the boundary surfaces delimiting the divided domain is proportional to the three-halves power of the volume of the divided domain as much as possible. Therefore, the boundary-surface characteristic quantity of a divided domain can be regarded as a quantity that does not require a specific geometric shape of the divided domain. Such a characteristic with respect to the boundary-surface characteristic quantity of a divided domain similarly exists with respect to the boundary-surface characteristic quantity of an aggregated domain. For this reason, the boundary-surface characteristic quantity of an aggregated domain can be regarded as a quantity that does not require a specific geometric shape of the aggregated domain. Note that the control point of an aggregated domain will be referred to as the “aggregated control point”, below.

Also, in the present embodiment, the “discretized governing equation that uses only quantities that do not require quantities that specify geometrical shapes” means a discretized governing equation in which values to be substituted consist of only quantities that do not require vertices and connectivity.

In the case of a numerical analysis method using the present embodiment, in the solver process (a calculation process of a physical quantity in the present embodiment), a discretized governing equation using only quantities that do not require quantities that specify geometrical shapes is used to calculate the physical quantity in the aggregated domains. Because of this, when solving the discretized governing equation, there is no need to include vertices and connectivity in the first and second calculation data models generated in the preprocess.

Then, in the case of using the present embodiment, as quantities that do not require quantities that specify geometrical shapes, the volumes of the aggregated domains and the boundary-surface characteristic quantities of the aggregated domains are used. Because of this, a calculation data model generated in the preprocess does not have vertices and connectivity, but is generated to have the volumes of the aggregated domains, the boundary-surface characteristic quantities of the aggregated domains, and other auxiliary data (e.g., linkage information of the aggregated domains and the coordinates of aggregated control points, as will be described later).

In this way, in the case of using the present embodiment, as described above, based on the volumes and the boundary-surface characteristic quantities of the aggregated domains as quantities that do not require quantities that specify geometrical shapes, a physical quantity in each domain can be calculated. Because of this, it is possible to calculate the physical quantity without giving quantities that specify geometrical shapes of the aggregated domains in a second calculation data model. Therefore, by using the present embodiment, it is sufficient in the preprocess to generate a second calculation data model having at least the volumes and the boundary-surface characteristic quantities (the areas of the boundary surfaces and the normal vectors of the boundary surfaces) of the aggregated domains, which enables to calculate the physical quantity without generating a calculation data model having quantities that specify geometrical shapes.

Since the second calculation data model not having quantities that specify geometrical shapes does not require quantities that specify geometrical shapes of aggregated domains, the model can be generated without being bound by quantities that specify geometrical shapes of the aggregated domains.

Because of this, restrictions imposed on correction work of three-dimensional shape data are alleviated considerably. Therefore, the second calculation data model not having quantities that specify geometrical shapes can be generated far more easily as compared with a calculation data model that has quantities that specify geometrical shapes. Therefore, according to the present embodiment, the workload in generating a calculation data model can be reduced.

Also, even in the case of using the present embodiment, in the preprocess, quantities that specify geometrical shapes may be used. In other words, in the preprocess, the volumes, the boundary-surface characteristic values, and the like of divided domains may be calculated using quantities that specify the geometrical shapes. Even in such a case, since it is possible in the solver process to calculate the physical quantity as long as the volumes and the boundary-surface characteristic values of the aggregated domains are available, even if the quantities that specify geometrical shapes are used in the preprocess, no constraint is imposed on the geometric shapes of the aggregated domains, for example, no constraint resulted from distortion or twist of the divided domains, and the workload in generating the calculation data model can be reduced.

Further, by using the present embodiment, since no constraint is imposed on the geometric shapes of the divided domains in the preprocess, the aggregated domains can be changed into any shapes. Because of this, it becomes possible to easily fit the analysis domain to a domain that is desired to be analyzed practically without increasing the number of aggregated domains, and it becomes possible to improve the analysis precision without increasing the calculation load.

Furthermore, since the distribution density of the aggregated domains can also be discretionarily changed by using the present embodiment, it is also possible to further improve the analysis precision while allowing an increase of the calculation load within a necessary range.

In the present embodiment, in the preprocess, first, a first calculation data model with respect to divided domains is generated that includes the volumes and the boundary-surface characteristic quantities (the areas of the boundary surfaces and the normal vectors of the boundary surfaces) of the divided domains that are discretionarily arranged, and information that associates divided domains that exchange a physical quantity with each other. For example, this information that associates divided domains that exchange a physical quantity with each other consists of linkage information on divided domains adjacent to each other (links) and the distances between the adjacent domains adjacent to each other. Further, the divided domains associated by this link are not necessarily spatially adjacent to each other, and may be spatially separated from each other. Such a link is not related to quantities that specify geometrical shapes, and compared with quantities that specify geometrical shapes, it can be generated within an extremely shorter time. Also, as will be described in detail later, in the present embodiment, when necessary, there may be a case where coordinates of a control point arranged inside a divided domain are included in the first calculation data model. Next, in the present embodiment, in the preprocess, multiple divided domains are aggregated to generate a requested number of aggregated domains. Then, a second calculation data model is generated that includes the volumes and the boundary-surface characteristic quantities (the areas of the boundary surfaces and the normal vectors of the boundary surfaces) of the aggregated domains, and information that associates aggregated domains that exchange the physical quantity with each other. The information that associates aggregated domains that exchange the physical quantity with each other and linkage information on aggregated domains adjacent to each other (links) also have a similar characteristic with respect to the characteristic of the divided domains. Also, as will be described in detail later, in the present embodiment, when necessary, there may be a case where coordinates of a control point arranged inside an aggregated domain are included in the second calculation data model.

Then, in the present embodiment, the preprocess transfers to the solver process the first calculation data model with respect to the divided domains that includes the volumes, the boundary-surface characteristic quantities, the links, and the coordinates of the control points of the divided domains; boundary conditions; initial conditions; and the like. The solver process solves a discretized governing equation by using the volumes, the boundary-surface characteristic quantities, and the like of the divided domains included in the transferred first calculation data model, to calculate the physical quantity.

Also, in the present embodiment, the preprocess also transfers to the solver process the second calculation data model with respect to the aggregated domains that includes the volumes, the boundary-surface characteristic quantities, the links, and the coordinates of the control points of the aggregated domains; boundary conditions; initial conditions; and the like. The solver process solves a discretized governing equation by using the volumes, the boundary-surface characteristic quantities, and the like of the aggregated domains included in the transferred second calculation data model, to calculate the physical quantity.

In the present embodiment, the solver process calculates the physical quantity without using quantities that specify geometrical shapes, which is significantly different from the conventional finite volume method, and this point is a significant feature of the present embodiment. Such a feature is obtained by using a discretized governing equation that uses only quantities that do not require quantities that specify geometrical shapes in the solver process.

Consequently, in the present embodiment, there is no need to transfer quantities that specify geometrical shapes to the solver process, and the preprocess simply needs to generate a calculation data model not having quantities that specify geometrical shapes. Therefore, as compared with the conventional finite volume method, it is possible to generate a calculation data model far more easily in the present embodiment, and it is possible to reduce the workload in generating a calculation data model.

First, a flow of a process of numerical analysis in a numerical analysis method using the present embodiment will be briefly described.

As described above, a numerical analysis method using the present embodiment includes a process of dividing an analysis domain into multiple divided domains (referred to as the “process of dividing into multiple divided domains”, below). The present numerical analysis method further includes a process of generating a first calculation data model based on a discretized governing equation with respect to the divided domains that uses only quantities that do not require coordinates of vertices of the divided domains and connectivity information on the vertices (referred to as the “process of generating a first calculation data model with respect to divided domains”, below); the discretized governing equation is derived based on a weighted residual method; and the calculation data model includes the volume of each divided domain and a divided-domain characteristic quantity representing a characteristic quantity of the divided domain with respect to each adjacent domain as the quantities that do not require the coordinates of the vertices of the divided domain and the connectivity information on the vertices.

The present numerical analysis method further includes a process of generating a requested number of aggregated domains by aggregating multiple divided domains (referred to as the “process of generating aggregated domains”, below). The present numerical analysis method further includes a process of generating a second calculation data model based on a discretized governing equation with respect to the aggregated domains that uses only quantities that do not require coordinates of vertices of the aggregated domains and connectivity information on the vertices (referred to as the “process of generating a second calculation data model with respect to aggregated domains”, below); the discretized governing equation is derived based on a weighted residual method; and the calculation data model includes the volume of each aggregated domain and an aggregated-domain characteristic quantity representing a characteristic quantity of the aggregated domain with respect to each adjacent domain as the quantities that do not require the coordinates of the vertices of the aggregated domains and the connectivity information on the vertices. The present numerical analysis method further includes a process of calculating a physical quantity based on a physical property of the analysis domain, and the calculation data model with respect to the aggregated domains.

(Process of Dividing into Multiple Divided Domains)

The process of dividing an analysis domain into multiple divided domains for generating a first calculation data model will be described. In the process of dividing an analysis domain into multiple divided domains, the analysis domain is finely divided into cells without using quantities that specify geometrical shapes.

(Process of Generating First Calculation Data Model with Respect to Divided Domains)

The process of generating a first calculation data model with respect to divided domains will be described. Note that this process of generating a first calculation data model with respect to divided domains is substantially the same as a process disclosed in Patent document 1.

In FIG. 1, cells R₁, R₂, R₃, and so on are divided domains obtained by dividing an analysis domain, each of which has the volume Vₐ, V_{b}, V_{c}, and so on. Also, a boundary surface E is a surface where a physical quantity is exchanged between the cell R₁ and the cell R₂, which corresponds to the boundary surface in the present embodiment. Also, an area S_{ab} represents the area of the boundary surface E, which is one of the boundary-surface characteristic quantities in the present embodiment. Also, [n]_{ab} represents a normal vector of the boundary surface E, which is one of the boundary-surface characteristic quantities in the present embodiment.

Also, control points a, b, c, and so on are arranged inside the respective cells R₁, R₂, R₃, and so on, and in FIG. 1, arranged at positions corresponding to the center of gravity of the cells R₁, R₂, R₃, and so on. However, the control points a, b, c, and so on are not necessarily arranged at the positions corresponding to the center of gravity of the cells R₁, R₂, R₃, and so on. Also, a represents the distance from the control point a to the boundary surface E in the case of defining the distance from the control point a to the control point b as 1, or represents a ratio designating an internally dividing point on the line segment connecting the control point a and the control point b at which the boundary surface E exists. Note that the distance from the control point a to the control point b is an example of the distance between divided domains adjacent to each other.

Note that a boundary surface exists not only between the cell R₁ and the cell R₂, but also between every two cells adjacent to each other. In addition, the no/mal vector of the boundary surface and the area of the boundary surface are also given for each of the boundary surfaces.

Further, a first calculation data model with respect to divided domains in practice is constructed as a group of data items that includes arrangement data of the control points a, b, c, and so on; volume data representing the volumes Vₐ, V_{b}, V_{c}, and so on of the cells R₁, R₂, R₃, and so on in which the control points a, b, c, and so on exist, respectively; area data representing the area of each boundary surface; and normal vector data representing the normal vector of each of the boundary surfaces (referred to as the “normal vector”, below).

This means that the first calculation data model with respect to divided domains in the present numerical analysis method is defined to include the volumes Vₐ, V_{b}, V_{c}, and so on of the cells R₁, R₂, R₃, and so on, respectively; the area of each boundary surface as the boundary-surface characteristic quantity representing a characteristic of the boundary surface with respect to the corresponding one of the adjacent cells R₁, R₂, R₃, and so on; and the normal vector of each boundary surface as the boundary-surface characteristic quantity representing a characteristic of the boundary surface with respect to the corresponding one of the adjacent cells R₁, R₂, R₃, and so on.

Note that the cells R₁, R₂, R₃, and so on have the control points a, b, c, and so on, respectively. Because of this, the volumes Vₐ, V_{b}, V_{c}, and so on of the cells R₁, R₂, R₃, and so on can be regarded as the volumes of spaces (control volumes) that are virtually occupied by the control points a, b, c, and so on, respectively.

Also, the first calculation data model in the present numerical analysis method includes, where necessary, ratio data that represents a ratio designating an internally dividing point on a line segment connecting control points interposing a boundary surface in-between, at which the boundary surface exists.

In the following, an example of a physical quantity calculation will be described in which the flow velocity in each cell of an analysis domain is obtained by using a first calculation data model as described above. Note that here, the flow velocity at each control point is obtained as the flow velocity in each cell.

First, in the present physical quantity calculation, in the case of fluid analysis, the present numerical analysis method uses the Navier-Stokes equation expressed as the following Equation (1) and the equation of continuum expressed as the following Equation (2).

$$\begin{matrix}\frac{\partial }{\partial t} ( ρ {u}_{i} ) + \frac{\partial }{\partial {x}_{j}} ( ρ {u}_{j} {u}_{i} ) = - \frac{\partial P}{\partial {x}_{i}} + \frac{\partial }{\partial {x}_{j}} [ μ \frac{\partial {u}_{i}}{\partial {x}_{j}} ] & ( 1 ) \\ \frac{\partial ( ρ {u}_{j} )}{\partial {x}_{j}} = 0 & ( 2 )\end{matrix}$$

where in Equations (1) and (2), t represents time; xᵢ (i=1, 2, 3) represents a coordinate in a Cartesian system; ρ represents the fluid density; uᵢ (i=1, 2, 3) represents a flow velocity component of the fluid; P represents the pressure; μ represents the viscous coefficient of the fluid; and the subscripts i (1=1, 2, 3) and j (j=1, 2, 3) represent respective components in the respective directions in the Cartesian coordinate system. Also, the subscript j follows the summation convention.

Then, based on a weighted residual method, by integrating Equations (1) and (2) with respect to the volume of the control volume of a divided domain, Equation (1) is expressed as the following Equation (3), and Equation (2) is expressed as the following Equation (4).

$$\begin{matrix}{\int }_{V} \frac{\partial }{\partial t} ( ρ {u}_{i} ) dV + {\int }_{S}^{ } ( n \cdot u ) {u}_{i} dS = - {\int }_{S}^{ } {n}_{i} PdS + {\int }_{S}^{ } μ \frac{\partial {u}_{i}}{\partial n} dS & ( 3 ) \\ {\int }_{S}^{ } ρ n \cdot udS = 0 & ( 4 )\end{matrix}$$

where in Equations (3) and (4), V represents the volume of the control volume; ∫_{V}dV represents the integration with respect to the volume V; S represents the area of the control volume; ∫_{S}dS represents the integration with respect to the area S; [n] represents a normal vector of S; nᵢ (i=1, 2, 3) represents respective components of the normal vector [n]; and ∂/∂n represents the normal derivative.

Here, in order to simplify the description, the density ρ and the viscosity coefficient μ of the fluid are assumed to be constants. However, the constants assumed as such can be extended to a case where a physical property of the fluid changes depending on time, space, temperature, and the like.

Then, with respect to the control point a in FIG. 1, by discretizing with the area S_{ab} of the boundary surface E and by transforming into an approximation expressed as an algebraic equation, Equation (3) is expressed as the following Equation (5), and Equation (4) is expressed as the following Equation (6).

$$\begin{matrix}{V}_{a} \cdot ρ \frac{\partial {u}_{i}}{\partial t} + {\sum }_{b = 1}^{m} [ {S}_{ab} \cdot ( {n}_{ab} \cdot {u}_{ab} ) {u}_{iab} ] = - {\sum }_{b = 1}^{m} [ {S}_{ab} \cdot {n}_{iab} \cdot {P}_{ab} ] + {\sum }_{b = 1}^{m} [ {S}_{ab} \cdot μ \cdot {( \frac{\partial {u}_{i}}{\partial n} )}_{ab} ] & ( 5 ) \\ {\sum }_{b = 1}^{m} [ {S}_{ab} \cdot ( {n}_{ab} \cdot {u}_{ab} ) ] = 0 & ( 6 )\end{matrix}$$

where each of [n]_{ab}, [u]_{ab}, u_{iab}, n_{iab}, P_{ab}, and (∂uᵢ/∂n)_{ab} with the subscript ab represents a physical quantity on the boundary surface E between the control point a and the control point b. Also, n_{iab} is a component of [n]_{ab}. Also, m represents the number of all control points each of which has a connection relationship (relationship of having a boundary surface in-between) with the control point a.

Then, by dividing Equations (5) and (6) by Vₐ (the volume of the control volume of the control point a), Equation (5) is expressed as the following Equation (7), and Equation (6) is expressed as the following Equation (8).

$$\begin{matrix}ρ \frac{\partial {u}_{i}}{\partial t} + {\sum }_{b = 1}^{m} [ \frac{{S}_{ab}}{{V}_{a}} \cdot ( {n}_{ab} \cdot {u}_{ab} ) {u}_{iab} ] = - {\sum }_{b = 1}^{m} [ \frac{{S}_{ab}}{{V}_{a}} \cdot {n}_{iab} \cdot {P}_{ab} ] + {\sum }_{b = 1}^{m} [ \frac{{S}_{ab}}{{V}_{a}} \cdot μ \cdot {( \frac{\partial {u}_{i}}{\partial n} )}_{ab} ] & ( 7 ) \\ {\sum }_{b = 1}^{m} [ \frac{{S}_{ab}}{{V}_{a}} \cdot ( {n}_{ab} \cdot {u}_{ab} ) ] = 0 & ( 8 )\end{matrix}$$

Here, by replacing with the following Equation

$${φ}_{ab} ≡ \frac{{S}_{ab}}{{V}_{a}} \qquad ( 9 )$$

then, Equation (7) is expressed as the following Equation (10), and Equation (8) is expressed as the following Equation (11).

$$\begin{matrix}ρ \frac{\partial {u}_{i}}{\partial t} + {\sum }_{b = 1}^{m} [ {φ}_{ab} \cdot ( {n}_{ab} \cdot {u}_{ab} ) {u}_{iab} ] = - {\sum }_{b = 1}^{m} [ {φ}_{ab} \cdot {n}_{iab} \cdot {P}_{ab} ] + {\sum }_{b = 1}^{m} [ {φ}_{ab} \cdot μ \cdot {( \frac{\partial {u}_{i}}{\partial n} )}_{ab} ] & ( 10 ) \\ {\sum }_{b = 1}^{m} [ {φ}_{ab} \cdot ( {n}_{ab} \cdot {u}_{ab} ) ] = 0 & ( 11 )\end{matrix}$$

In Equations (10) and (11), each of [u]_{ab}, u_{iab}, P_{ab}, and (∂uᵢ/∂n)_{ab} is obtained approximately as a weighted average of physical quantities on the control point a and the control point b (a weighted average considering the upwind scheme in the case of an advective term), and is determined depending on the distance and the direction between the control points a and b; the positional relationship with the boundary surface E located in-between (the above ratio α); and the direction of the normal vector of the boundary surface E. Note that [u]_{ab}, u_{iab}, P_{ab}, and (∂uᵢ/∂n)_{ab} are quantities unrelated to quantities that specify the geometrical shape of the boundary surface E. Also, ϕ_{ab} defined by Equation (9) is a quantity that represents (area/volume), and is also a quantity unrelated to quantities that specify the geometrical shape of a control volume.

In other words, Equations (10) and (11) as such are arithmetic equations based on a weighted residual method, with which a physical quantity can be calculated only using quantities that do not require quantities that specify geometrical shapes specifying cell shapes.

Because of this, by generating the above-mentioned first calculation data model prior to the physical quantity calculation (the solver process) and by using the first calculation data model and the discretized governing equations expressed as Equations (10) and (11) in the physical quantity calculation, it is possible to calculate the flow velocity without using quantities that specify geometrical shapes of the control volumes at all in the physical quantity calculation.

In this way, since it is possible to calculate the flow velocity without using quantities that specify geometrical shapes at all in the physical quantity calculation, there is no need to have quantities that specify geometrical shapes in the first calculation data model. Therefore, when generating the first calculation data model, it is not necessary to be bound by the geometric shapes of the cells, and hence, the shapes of the cells can be set discretionarily. Because of this, according to the present numerical analysis method, as described above, it is possible to significantly alleviate the restrictions on the work of modifying three-dimensional shape data.

Note that when solving Equation (10) and (11) in practice, the physical quantities on the boundary surface E, such as [u]_{ab}, u_{iab}, and P_{ab} are normally interpolated by linear interpolation. For example, denoting a physical quantity of the control point a by ψₐ and a physical quantity of the control point b by ψ_{b}, a physical quantity ψ_{ab} on the boundary surface E can be obtained by the following Equation (12).

ψ_{ab}=½(ωₐ+ψ_{b}) (12)

Alternatively, the physical quantity ψ_{ab} can also be obtained by the following Equation (13) by using the ratio α designating an internally dividing point on a line segment connecting the control points interposing the boundary surface in-between, at which the boundary surface exists.

ψ_{ab}=(1−α)·ψₐ+α·ψ_{b} (13)

Therefore, in the case where the first calculation data model has the ratio data representing the ratio α, by using Equation (13), it is possible to calculate the physical quantity on the boundary surface E by using a weighted average in accordance with separating distances from the control point a and the control point b.

In addition, as expressed in Equation (1), an equation of a continuum model (the Navier-Stokes equation, etc.) includes a first-order partial derivative (partial differentiation).

Here, for the differential coefficients in the equation of the continuum model, the order of differentiation is lowered by transforming a volume integral into a surface integral by using integration by parts, Gauss's divergence theorem, or the generalized Green's theorem. This enables to transform the first-order differential into a zeroth-order differential (a scalar quantity or a vector quantity).

For example, in the generalized Green's theorem, denoting a physical quantity by 11J, a relationship as in the following Equation (14) holds.

$${\int }_{V} \frac{\partial ψ}{\partial {x}_{i}} dV = {\int }_{S}^{ } ψ {n}_{i} dS \qquad ( 14 )$$

where in Equation (14), nᵢ (i=1, 2, or 3) is a component in the i-direction of a unit normal vector [n] of the surface S.

By transforming the volume integral into the surface integral, the first-order derivative term of the equation of the continuum model is handled as a scalar quantity or a vector quantity on the boundary surface. Also, these values can be interpolated from the physical quantities on the control points by the linear interpolation or the like as described above.

Also, a second-order partial derivative may be included depending on the equation of the continuum model.

An equation obtained by further applying first-order differentiation to the integrand of Equation (14) is expressed as the following Equation (15), and the second-order derivative term of the equation of the continuum model is expressed as the following Equation (16) on the boundary surface E by the transformation from the volume integral into the surface integral.

$$\begin{matrix}{\int }_{V} \frac{{\partial }^{2} ψ}{\partial {x}_{i} \partial {x}_{j}} dV = {\int }_{S} \frac{\partial ψ}{\partial {x}_{j}} {n}_{i} dS = {\int }_{S} \frac{\partial ψ}{\partial n} {n}_{i} {n}_{j} dS & ( 15 ) \\ {\int }_{{S}_{ab}} \frac{\partial ψ}{\partial {n}_{ab}} \cdot {n}_{iab} \cdot {n}_{jab} dS & ( 16 )\end{matrix}$$

where in Equation (15), ∂/∂n represents the no mal derivative, and in Equation (16) ∂/∂n_{ab} represents the directional derivative in the direction of [n]_{ab}.

In other words, by the transformation from the volume integral into the surface integral, the second-order derivative term in the equation of the continuum model takes a form in which the normal derivative of the physical quantity ψ (the directional derivative in the direction of the normal [n]ab of S_{ab}) is multiplied by components n_{iab} and n_{jab} of [n].

Here, ∂ψ/∂n_{ab} in Equation (16) is approximated by the following Equation (17).

$$\frac{\partial ψ}{\partial {n}_{ab}} = \frac{{ψ}_{b} - {ψ}_{a}}{{r}_{ab} \cdot {n}_{ab}} \qquad ( 17 )$$

Note that an inter-control-point vector [r]_{ab} between the control point a and the control point b is defined as in the following Equation (18) from the position vector [r]ₐ of the control point a and the position vector [r]_{b} of the control point b.

r_{ab}=r_{b}−rₐ (18)

Therefore, as S_{ab} represents the area of the boundary surface E, Equation (16) turns out to be the following Equation (19), and by using this, Equation (16) can be calculated.

$${\int }_{{S}_{ab}} \frac{\partial ψ}{\partial {n}_{ab}} \cdot {n}_{iab} \cdot {n}_{jab} dS = {S}_{ab} \cdot \frac{{ψ}_{b} - {ψ}_{a}}{{r}_{ab} \cdot {n}_{ab}} \cdot {n}_{iab} \cdot {n}_{jab} \qquad ( 19 )$$

Note that the derivation of Equation (16) brings out the following matters.

Every linear partial differential equation is expressed by a linear sum of constant and partial derivative terms of first-order, second-order, and so on multiplied by respective coefficients. By replacing the physical quantity ψ with the first-order partial derivative of ψ in Equations (15) to (19), it is possible to obtain the volume integral as a higher-order partial derivative by the surface integral as a lower-order partial derivative as in Equation (14). Repeating this procedure one by one starting from a low-order partial differential, it becomes possible to calculate the partial derivative of every term constituting the linear partial differential equation from the physical value ψ at the control point; ψ_{ab} as ψ on the boundary surface calculated by Equation (12) or Equation (13); the inter-control-point distance obtained from the inter-control-point vector defined by Equation (18); the area S_{ab} of the boundary surface E; and the components n_{iab} and n_{jab} of the normal vector of the boundary surface E.

As described above, the physical quantity calculation in the present numerical analysis method does not require quantities that specify geometrical shapes. Because of this, when generating a first calculation data model (preprocess), once the volumes of control volumes, and the areas and the normal vector of boundary surfaces are obtained without using quantities that specify geometrical shapes, by using the discretized governing equations of Equation (10) and Equation (11), it is possible to calculate the flow velocity without using the geometric shapes of the cells as the geometric shapes of the control volumes at all.

However, in the present numerical analysis method, the volumes of the control volumes and the areas and the normal vector of the boundary surfaces do not necessarily need to be obtained without using the geometric shapes of the control volumes. As such, since quantities that specify geometrical shapes are not necessarily used in the solver process, even if specific geometric shapes of the control volumes, specifically, the vertices and connectivity are used, there is no constraint on the divided domains as in the conventional finite element method and finite volume method, namely, no constraint resulted from distortion or twist of the divided domains; therefore, it is possible to easily generate a calculation data model as described above.

Note that in the description described above, although an example of calculation of a physical quantity has been described in which discretized governing equations derived based on a weighted residual method from the Navier-Stokes equation and the equation of continuum are used, the discretized governing equations that can be used in the present numerical analysis method are not limited to these.

In other words, any discretized governing equation can be used in the present numerical analysis method as long as it is derived from among various equations (the mass conservation equation, the equation for conservation of momentum, the equation for conservation of energy, the advection-diffusion equation, the wave equation, etc.) based on a weighted residual method, and is capable of calculating a physical quantity by using only quantities that do not require quantities that specify geometrical shapes.

Moreover, such characteristics of the discretized governing equations enable so-called meshless calculation in which the mesh is not required, unlike the conventional finite element method or finite volume method. Further, even if quantities that specify geometrical shapes of cells are used in the preprocess, since there is no constraint on the mesh as imposed in the conventional finite element method, the finite volume method, and the voxel method, it is possible to reduce the workload accompanying generation of the first calculation data model.

In the present embodiment, it is possible to derive a discretized governing equation that uses only quantities that do not require quantities that specify geometrical shapes, based on a weighted residual method, from the mass conservation equation, the equation for conservation of momentum, the equation for conservation of energy, the advection-diffusion equation, and the wave equation. For this reason, in the present numerical analysis method, it is possible to use other governing equations. In this regard, the reason is substantially the same as described in Patent document 1, and the description is omitted here.

(Process of Generating Aggregated Domains)

Next, a process of generating aggregated domains from divided domains for generating a second calculation data model in the present numerical analysis method will be described. In the process of generating aggregated domains, an aggregated domain is generated by an aggregated sum of cells. In the following, an aggregated domain may be referred to as a “domain”. Once domains are generated, the analysis domain transitions to a state of being divided by the domains.

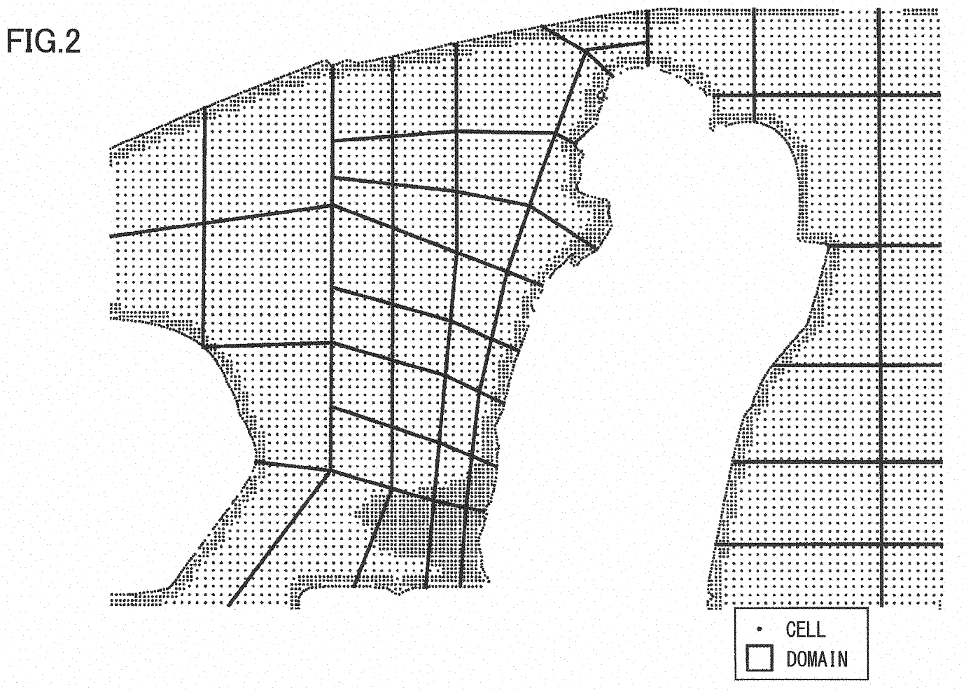

In the process of generating aggregated domains in FIG. 2, a domain is defined as a control volume that is newly set by aggregating control volumes (cells) generated automatically in the analysis domain. The domain is a control volume and is an aggregated sum of cells.

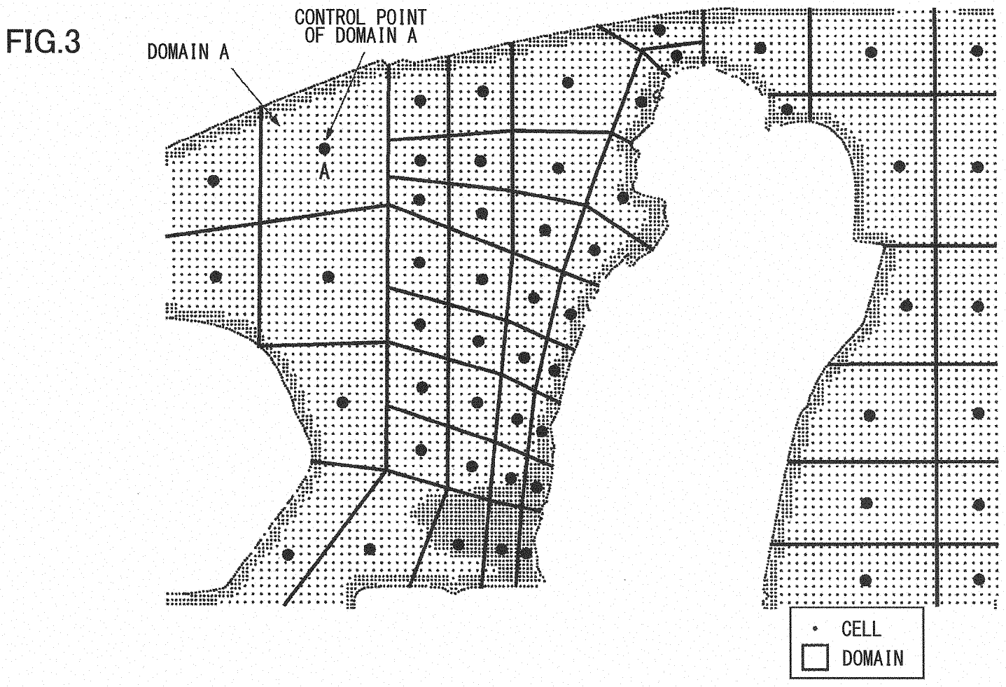

Among multiple domains illustrated in FIG. 3, suppose that a domain A represents any one of the domains. Denoting the total number of cells that exist in the domain A by NV_{A}, the volume V_{A} of the domain A is expressed as Equation (20), and the coordinate vector [r]_{A} of the control point of the domain A is expressed as Equation (21). By the following Equation (20) and Equation (21), an aggregated sum of cells is calculated to set a domain.

$$\begin{matrix}{V}_{A} = {\sum }_{a = 1}^{{NV}_{A}} {V}_{a} & ( 20 ) \\ {V}_{A} \cdot {r}_{A} = {\sum }_{a = 1}^{{NV}_{A}} [ {V}_{a} \cdot {r}_{A} ] & ( 21 )\end{matrix}$$

where in Equations (20) and (21), A, B, and so on are subscripts representing respective domains.

Here, after having set domains, a domain may be newly set by aggregating the domains having been set.

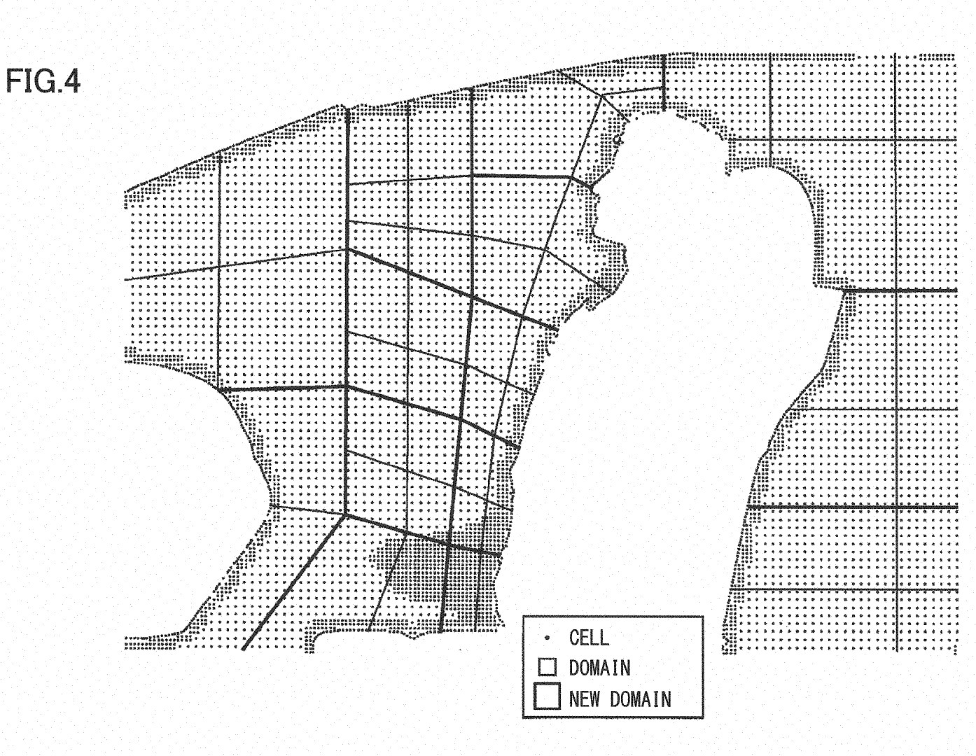

As illustrated in FIG. 4, an aggregated sum of multiple domains are set. In the example illustrated in FIG. 4, a domain is drawn by thin lines.

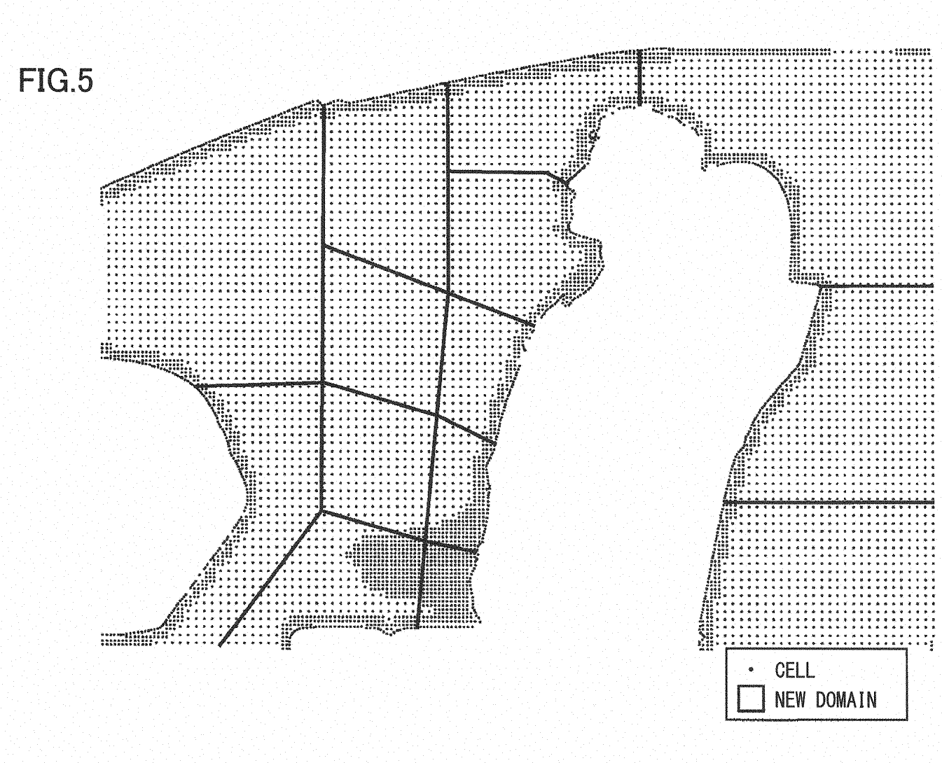

As illustrated in FIG. 5, a domain is newly set by aggregating multiple domains. A newly set domain is drawn by thick lines.

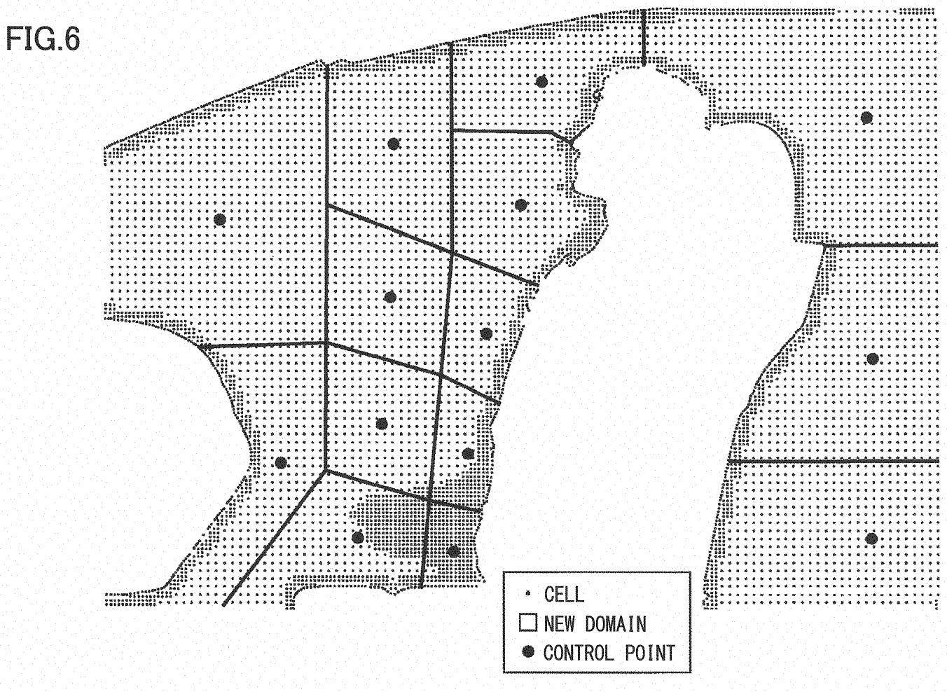

A newly set domain is also a control volume and is also an aggregated sum of domains. For each newly set domain, the volume of the newly set domain and the coordinate vector of the control point of the newly set domain are calculated by Equation (20) and Equation (21). The control points are illustrated as illustrated in FIG. 6. In addition, a newly set domain is handled in substantially the same way as the other domains.

Here, it is denoted that a domain 1 is a domain generated by an aggregated sum of cells, a domain 2 is a domain generated by an aggregated sum of domains 1, and a domain 3 is a domain generated by an aggregated sum of domains 2. Based on control volumes (cells) automatically generated in an analysis domain, it is possible to set a hierarchical structure of domains including domains 1, domains 2, domains 3, so on, and the last domains.

In accordance with a requested calculation precision, it is possible to set a hierarchical structure of domains including domains 1, domains 2, domains 3, so on, and the last domains from control volumes (cells). Here, the last domains may be set from domains 1 without setting domains 2 or domains 3. In the case of setting a hierarchical structure of domains including domains 1, domains 2, domains 3, so on, and the last domains, or in the case of setting the last domains from domains 1 without setting domains 2 or domains 3, the cell-division precision with respect to the boundary shape of the initial analysis domain is not lost.

In the conventional finite volume method or finite element method, if initially divided meshes are aggregated, the boundary shape of an aggregated domain becomes one having complicated faces, and thereby, the calculation cannot be executed. Specifically, under the present circumstances, the finite volume method is limited to an icosahedron, and in the finite element method, an interpolation function in an element cannot be defined for a polyhedron exceeding a hexahedron. As such, in the conventional methods, the idea of aggregating initial divided meshes does not exist. Thus, in the circumstances where neither motivation nor implication of forming an aggregated domain from divided domains is found, the inventors conceived of the present embodiment, which brings remarkable effects that cannot be brought by the conventional methods.

With control volumes (cells) generated automatically, it is possible to execute numerical analysis while satisfying the conservation law of a physical quantity, such as mass balance (conservation of mass) between cells, the conservation of momentum, and the conservation of energy. Therefore, in either case of setting a hierarchical structure of domains including domains 1, domains 2, domains 3, so on, and the last domains, or setting the last domains from domains 1 without setting domains 2 or domains 3, the conservation law of a physical quantity holds between the domains.

A method of aggregating control volumes (cells) for newly setting domains by aggregating control volumes (cells) automatically generated in an analysis domain will be described.

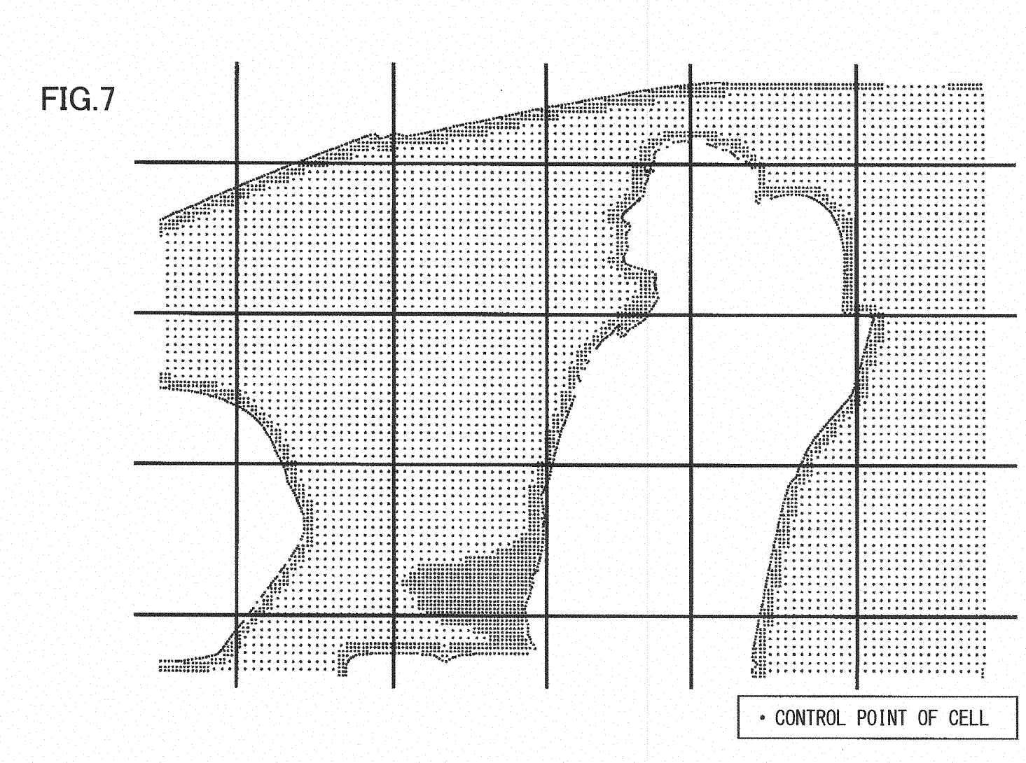

As illustrated in FIG. 7, the analysis domain is coarsely divided into regions forming orthogonal grids, and cells are aggregated such that the control points are included in the orthogonal grids.

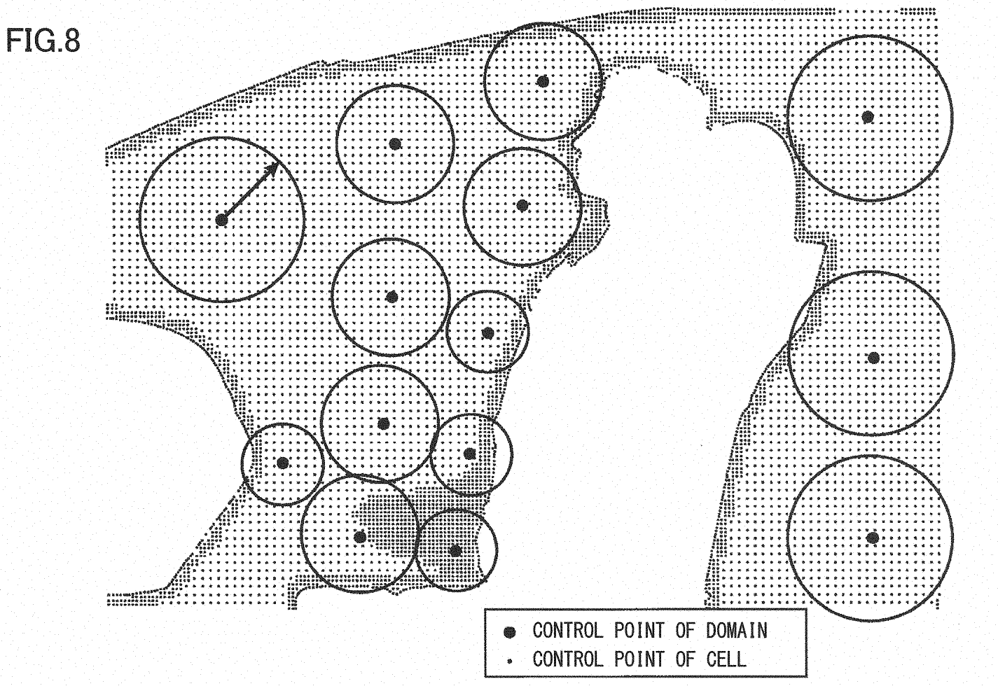

As illustrated in FIG. 8, the control points of the domains are set in the analysis domain. Cells whose control points are included in a sphere of a predetermined radius from the control point of each domain are aggregated. The radius is gradually enlarged so that all the cells in the analysis domain are aggregated in one of the domains.

Alternatively, by using the voxel method, voxels may be generated in a region covering the analysis domain, so as to have the voxels serve as the domains. In this case, cells whose control points are included in a voxel are aggregated.

Here, although three examples have been described as the methods of aggregating cells, the methods are not limited to these examples. For example, an aggregation method other than the examples described here may be used.

In the case of newly setting a domain by aggregating control volumes (cells) automatically generated in an analysis domain according to the method of aggregating the control volumes (cells), the cell-division precision with respect to the boundary shape of the initial analysis domain is not lost. Because of this, it is possible to execute numerical analysis while satisfying the conservation law of a physical quantity between the domains that are newly set by aggregating the control volumes (cells) automatically generated in the analysis domain according to the method of aggregating the control volumes (cells).

(Process of Generating Second Calculation Data Model with Respect to Aggregated Domains)

Further, a process of generating a second calculation data model with respect to aggregated domains will be described.

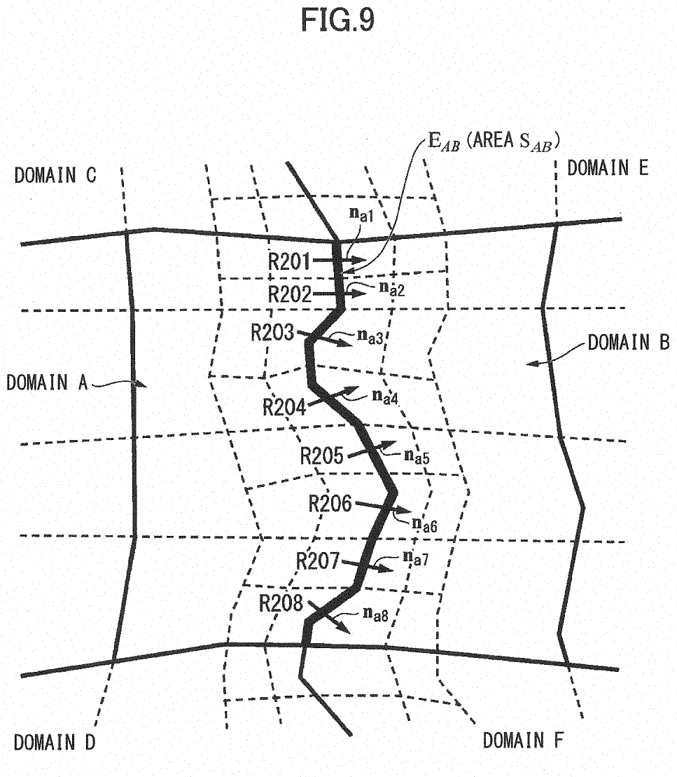

FIG. 9 is a conceptual diagram illustrating an example of a boundary-surface characteristic quantity of an aggregated domain in the numerical analysis method according to the invention. FIG. 9 illustrates multiple divided domains that divide an analysis domain, and multiple aggregated domains. In FIG. 9, a domain A and a domain B enclosed with solid lines are aggregated domains. In FIG. 9, figures enclosed with dashed lines are divided domains. For example, cells R201 to R208 are divided domains. The domain A is an aggregated domain obtained by aggregating multiple divided domains including the cells R201 to R208. A boundary surface E_{AB} is a surface through which a physical quantity is exchanged between the domain A and the domain B, and corresponds to a boundary surface in a second calculation data model. Also, the area S_{AB} represents the area of the boundary surface E_{AB}, which is one of the boundary-surface characteristic quantities of an aggregated domain in the present embodiment.

Each of [n]ₐ₁ to [n]ₐ₈ is a normal vector, which is a quantity representing a characteristic of the boundary surface of cells contacting each other on the boundary surface E_{AB}.

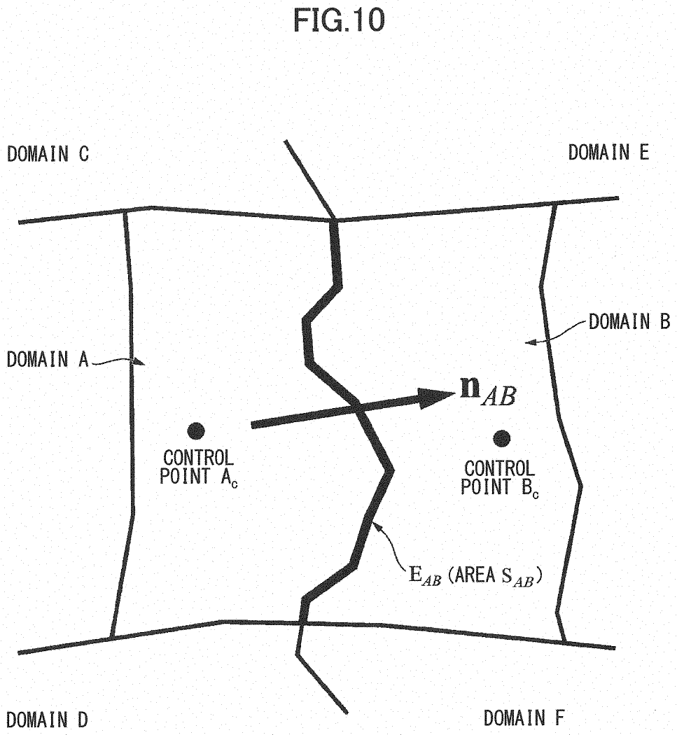

A domain A and a domain B in FIG. 10 correspond to the domain A and the domain B in FIG. 9, respectively. A control point A_{c} and a control point B_{c} are arranged inside the domain A and the domain B, respectively.

Denoting the total number of boundary surfaces of cells b that belong to the domain B and contact the boundary surface E_{AB} by NS_{AB}, the area S_{AB} of the boundary surface between the domain A and the domain B, and the normal vector [n]_{AB} of the boundary surface between the domain A and the domain B are calculated by Equation (22) and Equation (23), respectively, where S_{ab} represents the area of the boundary surface of a cell b that belongs to the domain B and contacts the boundary surface E_{AB}.

$${S}_{AB} = {\sum }_{b = 1}^{{NS}_{AB}} {S}_{ab} \qquad ( 22 )$$

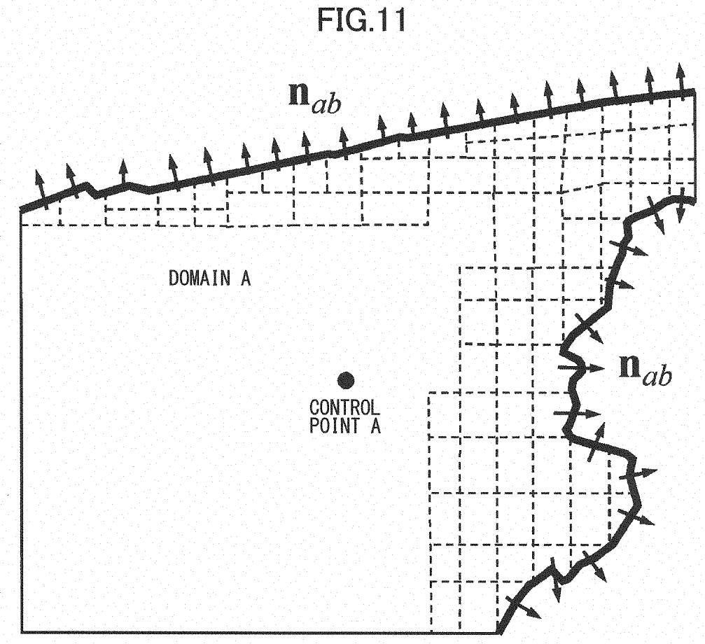

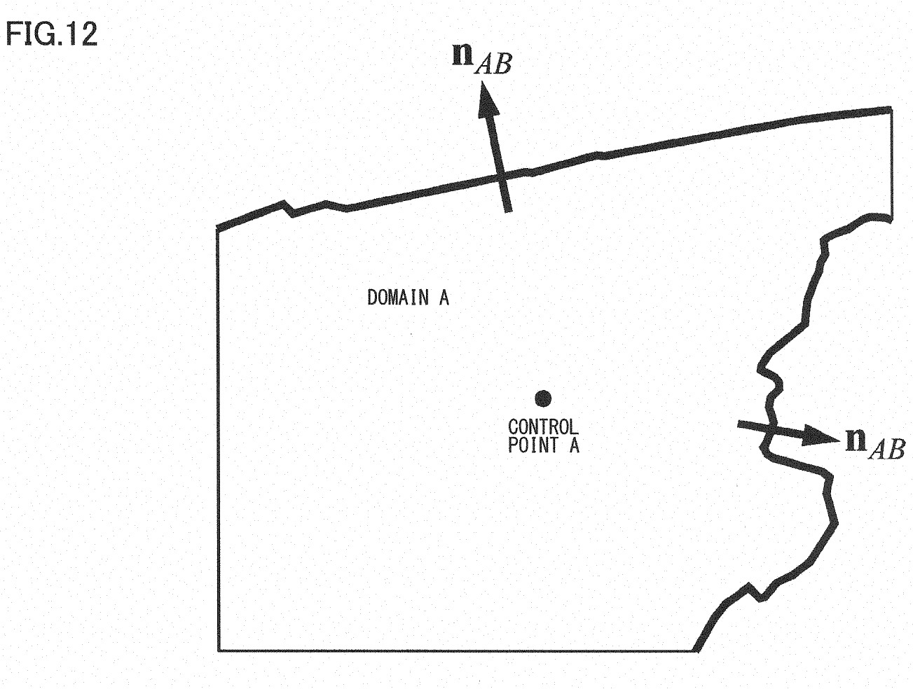

An example illustrated in FIG. 11 illustrates a case where a domain A contacts a boundary with the external space of the analysis domain. In this case, as illustrated in FIG. 12, assuming that a domain B exists outside of the analysis domain, by calculating an aggregated sum of boundary surfaces of cells a that contact the domain B, similarly to Equation (22) and Equation (23), the area S_{AB} of the boundary surface between the domain A and the domain B, and the normal vector [n]_{AB} of the boundary surface between the domain A and the domain B can be derived.

In the numerical analysis method described above, control volumes (cells) automatically generated in an analysis domain are aggregated to generate a domain.

Furthermore, in the numerical analysis method, by using the boundary-surface characteristic quantities of the boundary surface S_{ab} between the cell a and the cell b (the area S_{ab} of the boundary surface and the normal vector [n]_{ab} of the boundary surface) to calculate an aggregated sum with respect to the boundary surface S_{AB} between the domain A and the domain B, the boundary-surface characteristic quantities of the boundary surface S_{AB} between the domain A and the domain B (the area S_{AB} of the boundary surface and the normal vector [n]_{AB} of the boundary surface) are calculated. In other words, the numerical analysis method on a continuum with respect to cells, which does not use quantities that specify geometrical shapes, is applied to domains as completely the same calculation method.

Furthermore, based on control volumes (cells) automatically generated in an analysis domain, it is possible to set a hierarchical structure of domains including domains 1, domains 2, domains 3, so on, and the last domains. Therefore, the numerical analysis method of a continuum can be applied to all the domains set to have a hierarchical structure including domains 1, domains 2, domains 3, so on, and the last domains.

In either case of setting the last domains at once from control volumes (cells), or of setting a hierarchical structure of domains including domains 1, domains 2, domains 3, so on, and the last domains, the cell-division precision with respect to the boundary shape of the initial analysis domain is not lost. This is a very significant advantage in a numerical analysis in which the heat transfer area is regarded as important as in thermal fluid analysis.

In the case where the number of divisions of control volumes (cells) automatically generated in an analysis domain is as coarse as an order of below several tens to several thousands, a numerical analysis using the coarse number of divided cells may include many errors in an analysis result.

Meanwhile, although a numerical analysis with the number of divided cells of an order above several ten millions to several hundred millions exhibits a very high precision, the calculation level requires use of a supercomputer, namely, requires computing resources of a large memory capacity and HDD capacity, which leads to a significant increase of the calculation cost for a long computation time and a process of analyzing results.

However, regarding cell division of an order of several ten millions to several hundred millions of cells, if only the automatic generation of cells is required, it can be executed within a short time by a computer having a comparatively low-capacity memory.

Thereupon, it is possible to execute cell division of an order of several ten millions to several hundred millions in an analysis domain, and based on the cell division, to execute domain division to set a hierarchical structure including domains 1, domains 2, domains 3, so on, and the last domains. If the number of divisions of divided domains is an order of several thousands to several ten thousands, it is possible to execute a numerical analysis within a short time by a computer having a comparatively low-capacity memory.

In this case, although the boundary shape of a domain in which cells are aggregated may have very complicated faces, by using the numerical analysis method on a continuum based on cells, which does not use quantities that specify geometrical shapes, it is possible to execute the numerical analysis method on the continuum in a state where the cell-division precision with respect to the boundary shape of the initial analysis domain is maintained, within a short time, by a computer having a comparatively low-capacity memory, while curbing errors included in an analysis result so as not to be problematic.

Next, an example of a physical quantity calculation will be described that obtains flow velocity in an aggregated domain of an analysis domain by using the second calculation data model described above. Note that here, the flow velocity in each aggregated control point is obtained as the flow velocity in each aggregated domain.

Even in the case of using the second calculation data model, similar to the case of using the first calculation data model, first, the Navier-Stokes equation and the equation of continuum expressed as Equation (1) and Equation (2) are integrated with respect to the volume of an aggregated domain, based on a weighted residual method.

Consequently, Equations (3) and (4) are derived. However, in Equation (3) and (4), unlike the case of using the first calculation data model, V represents the volume of an aggregated domain; ∫_{V}dV represents the integral with respect to the volume V of the aggregated domain; S represents the area of the aggregated domain; ∫_{S}dS represents the integral with respect to the boundary surface S of the aggregated domain; [n] represents the normal vector of the boundary surface S of the aggregated domain; nᵢ (i=1, 2, or 3) represents a component of the normal vector [n] of the boundary surface S of the aggregated domain, and ∂/∂n represents the normal derivative of the boundary surface S of the aggregated domain.

As in the case of the first calculation data model, in the following, in order to simplify the description, the fluidic density ρ and the viscous coefficient μ of the fluid are assumed to be constants. However, as in the case of the first calculation data model, the constants assumed as such can be extended to a case where a physical property of fluid changes depending on time, space, temperature, and the like.

As illustrated in FIG. 9 and FIG. 10, with respect to the aggregated control point, by discretizing with the area S_{AB} of the boundary surface E_{AB} and by transforming into an approximation expressed as an algebraic equation, Equation (3) is expressed as the following Equation (24), and Equation (4) is expressed as the following Equation (25).

$${S}_{AB} \cdot {n}_{AB} = {\sum }_{b = 1}^{{NS}_{AB}} [ {S}_{ab} \cdot {n}_{ab} ] \qquad ( 23 )$$

where each of [n]_{AB}, [u]_{AB}, u_{iAB}, n_{iAB}, P_{AB}, and (∂uᵢ/∂n)_{AB} with the subscript AB is a physical quantity on the boundary surface E between the control point A and the control point B. Also, n_{iAB} is a component of [n]_{AB}. Also, mA is the number of all control points each of which has a connection relationship (relationship of having a boundary surface in-between) with the control point A.

Then, by dividing Equations (24) and (25) by V_{A} (the volume of the aggregated domain A), Equation (24) is expressed as the following Equation (26), and Equation (25) is expressed as the following Equation (27).

$$\begin{matrix}{V}_{A} \cdot ρ \frac{\partial {u}_{i}}{\partial t} + {\sum }_{B = 1}^{{m}_{A}} [ {S}_{AB} \cdot ( {n}_{AB} \cdot {u}_{AB} ) {u}_{iAB} ] = - {\sum }_{B = 1}^{{m}_{A}} [ {S}_{AB} \cdot {n}_{iAB} \cdot {P}_{AB} ] + {\sum }_{B = 1}^{{m}_{A}} [ {S}_{AB} \cdot μ \cdot {( \frac{\partial {u}_{i}}{\partial n} )}_{AB} ] & ( 24 ) \\ {\sum }_{B = 1}^{{m}_{A}} [ {S}_{AB} \cdot ( {n}_{AB} \cdot {u}_{AB} ) ] = 0 & ( 25 ) \\ ρ \frac{\partial {u}_{i}}{\partial t} + {\sum }_{B = 1}^{{m}_{A}} [ \frac{{S}_{AB}}{{V}_{A}} \cdot ( {n}_{AB} \cdot {u}_{AB} ) {u}_{iAB} ] = - {\sum }_{B = 1}^{{m}_{A}} [ \frac{{S}_{AB}}{{V}_{A}} \cdot {n}_{iAB} \cdot {P}_{AB} ] + {\sum }_{B = 1}^{{m}_{A}} [ \frac{{S}_{AB}}{{V}_{A}} \cdot μ \cdot {( \frac{\partial {u}_{i}}{\partial n} )}_{AB} ] & ( 26 ) \\ {\sum }_{B = 1}^{{m}_{A}} [ \frac{{S}_{AB}}{{V}_{A}} \cdot ( {n}_{AB} \cdot {u}_{AB} ) ] = 0 & ( 27 )\end{matrix}$$

Here, as in the case of the first calculation data model, replacing with the following Equation (28),

$${φ}_{AB} ≡ \frac{{S}_{AB}}{{V}_{A}} \qquad ( 28 )$$

then, Equation (26) is expressed as the following Equation (29), and Equation (27) is expressed as the following Equation (30).

$$\begin{matrix}ρ \frac{\partial {u}_{i}}{\partial t} + {\sum }_{B = 1}^{{m}_{A}} [ {φ}_{AB} \cdot ( {n}_{AB} \cdot {u}_{AB} ) {u}_{iAB} ] = - {\sum }_{B = 1}^{{m}_{A}} [ {φ}_{AB} \cdot {n}_{iAB} \cdot {P}_{AB} ] + {\sum }_{B = 1}^{{m}_{A}} [ {φ}_{AB} \cdot μ \cdot {( \frac{\partial {u}_{i}}{\partial n} )}_{AB} ] & ( 29 ) \\ {\sum }_{B = 1}^{{m}_{A}} [ {φ}_{AB} \cdot ( {n}_{AB} \cdot {u}_{AB} ) ] = 0 & ( 30 )\end{matrix}$$

In Equations (29) and (30), each of [u]_{AB}, u_{iAB}, P_{AB}, and (∂uᵢ/∂n)_{AB} is obtained approximately as a weighted average of physical quantities on the control point A and the control point B (a weighted average considering the upwind scheme in the case of an advective term), and is determined depending on the distance and the direction between the control points A and B; the positional relationship with the boundary surface E_{AB} located in-between (the above ratio α); and the direction of the normal vector of the boundary surface E. Note that [u]_{AB}, u_{iAB}, P_{AB}, and (∂uᵢ/∂n)_{AB} are quantities unrelated to quantities that specify the geometrical shape of the boundary surface E_{AB}.

Also, ϕ_{AB} defined by Equation (28) is a quantity representing (area/volume), and is also a quantity unrelated to quantities that specify the geometrical shape of the control volume of an aggregated domain.

In other words, Equations (29) and (30) as such are arithmetic equations based on a weighted residual method, with which a physical quantity can be calculated only using quantities that do not require vertices and connectivity that specify geometrical shapes of aggregated domains.

Because of this, by generating the above-mentioned second calculation data model prior to the physical quantity calculation (the solver process) and by using this calculation data model and the discretized governing equations expressed as Equations (29) and (30) in the physical quantity calculation, it is possible to calculate the flow velocity without using quantities that specify geometrical shapes of the aggregated domains at all in the physical quantity calculation.

In this way, since it is possible to calculate the flow velocity without using vertices and connectivity that specify geometrical shapes of the aggregated domains at all in the physical quantity calculation, as in the first calculation data model, there is no need to have quantities that specify geometrical shapes in the second calculation data model.

Note that when solving Equations (29) and (30) in practice, the physical quantities on the boundary surface E_{AB}, such as [u]_{AB} and P_{AB}, can be calculated as in the first calculation data model by using Expressions (12) to (19) for the first calculation data model where the physical quantity Ψ representing the physical quantity of a control point of a divided domain is replaced with the physical quantity of a control point of an aggregated domain; the area and the normal vector of a boundary surface of the divided domain is replaced with the area (Equation (22)) and the normal vector (Equation (23)) of a boundary surface of an aggregated domain; and in Equation (18) for the distance between control points of divided domains, the position (coordinates) vector of the control point of the divided domain is replaced with the position (coordinates) vector of the control point of the aggregated domain (Equation (21)).

Next, conditions with which the conservation law of a physical quantity is satisfied in the physical quantity calculation will be described. In the following, first, conditions with which the conservation law of a physical quantity is satisfied will be described in a calculation using the first calculation data model in the present numerical analysis.

In a calculation using the first calculation data model, assuming that in the equation of continuum (Equation (6)) that expresses the mass conservation law of divided domains, the area of a boundary surface between control points of divided domains is equivalent in either case of viewing from the control point a side, or of viewing from the control point b side, the mass flux between the control points (ρ[n]·[u])·S has a reversed plus or minus sign on either side of the control point a or of the control point b, and has an equivalent absolute value. Therefore, taking the total sum of Equation (6) with respect to all the divided domains in the analysis domain, the mass flux between the divided domains is canceled to be zero, which means that with respect to the entire analysis domain to be calculated, the mass flowing in is equivalent to the mass flowing out.

Therefore, in order to satisfy the mass conservation law with respect to the entire analysis domain to be calculated, it is necessary to satisfy a condition that the area of a boundary surface between two control points of divided domains is equivalent for the divided domains; and a condition that a normal vector of the boundary surface has a reversed plus or minus sign in either case of viewing from the control point on one side, or of viewing from the control point on the other side, and has an equivalent absolute value.

Further, in order to satisfy the mass conservation law, it is necessary to satisfy a condition that the total sum of the volumes occupied by the control volumes of divided domains is equivalent to the total volume Vₜₒₜₐₗ of the entire analysis domain as expressed in the following Equation (31), where N represents the total number of divided domains in the analysis domain.

$${V}_{total} = {\sum }_{a = 1}^{N} {V}_{a} \qquad ( 31 )$$

Note that here, although it has been described with respect to the equation of mass conservation, the conservation law should also be satisfied with respect to the momentum and the energy of a continuum. In order to satisfy the conservation law for these physical quantities by taking the total sum with respect to all the divided domains in the analysis domain, it is understood that it is necessary to satisfy a condition that the total sum of the volumes of the control volumes of all the divided domains in the analysis domain is equivalent to the total volume of the entire analysis domain; a condition that the area of a boundary surface between two control points of divided domains is equivalent for the divided domains; and a condition that a normal vector of the boundary surface has an equivalent absolute value (with the sign of plus or minus reversed) in either case of viewing from the control point on one side, or of viewing from the control point on the other side.

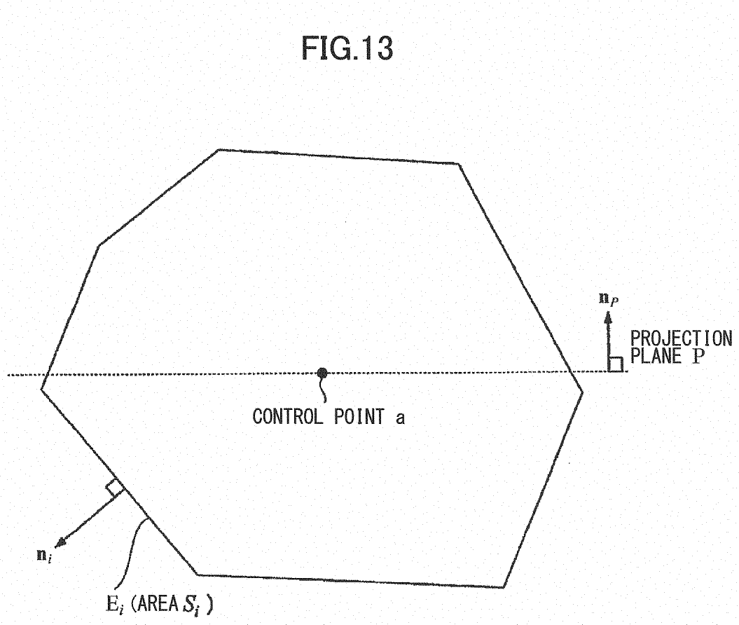

Further, in order to satisfy the conservation law, as illustrated in FIG. 13, considering a control volume occupied by a control point a of a divided domain, a condition is necessary that the following Equation (32) is satisfied considering an infinitely large projection plane P that passes through the control point a, and has a first unit normal vector [n]ₚ directed in an arbitrary direction. The unit normal vector is a normal vector having a unit length.

$${\sum }_{i = 1}^{m} [ ( {n}_{i} \cdot {n}_{p} ) \cdot {S}_{i} ] = 0 \qquad ( 32 )$$

where in FIG. 13 and Equation (32), Sᵢ represents the area of the boundary surface Eᵢ; [n]ᵢ represents the first unit normal vector of the boundary surface Eᵢ; and m represents the total number of surfaces of the control volume.

Equation (32) expresses that a polyhedron constituting a control volume constitutes a closure space. This Equation (32) is satisfied even if a part of the polyhedron constituting the control volume is dented.

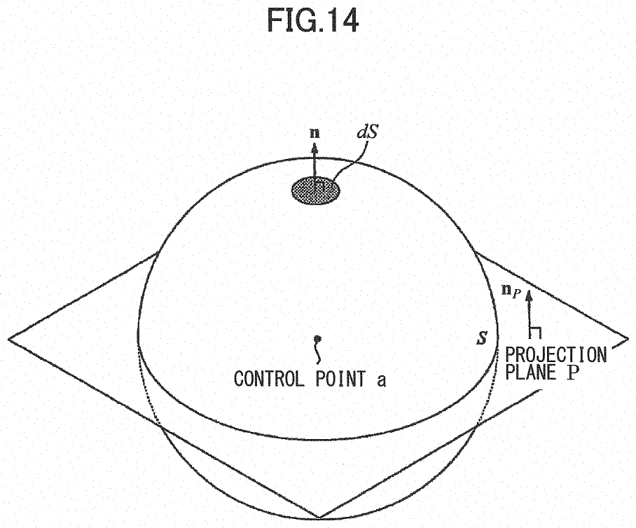

Also, by taking one surface of the polyhedron as a minute face dS, and taking the limit of m to infinity, the following Equation (33) is obtained, and it is understood that a curved surface object as illustrated in FIG. 14 also constitutes a closure space.

∫_{S}n·n_{P}dS=0 (33)

The condition that Equation (32) is satisfied is a necessary condition to satisfy Gauss' divergence theorem and the generalized Green's theorem expressed as Equation (14).

Moreover, the generalized Green's theorem is a fundamental theorem for discretization of a continuum. Therefore, in the case of transforming a volume integral into a surface integral to be discretized according to Green's theorem, in order to satisfy the conservation law, the condition that Equation (32) is satisfied is indispensable.

As such, when executing a numerical analysis using the first calculation data model and the physical quantity calculation as described above, in order to satisfy the conservation law of a physical quantity, the following three conditions are necessary (referred to as the “conditions for the first calculation”, below).

(a1) The total sum of volumes of control volumes of all control points (the volume of all divided domains) is equivalent to the volume of the analysis domain.

(b1) The area of a boundary surface between two control points is equivalent for the two control points; and a first normal vector of the boundary surface has an absolute value that is equivalent in either case of viewing from the control point on one side (one of the divided domains forming the boundary surface), or of viewing from the control point on the other side (the other of the divided domains forming the boundary surface).

(c1) Equation (32) is satisfied considering an infinitely large projection plane P that passes through a control point (passes through a divided domain), and has a first unit normal vector [n]ₚ directed in an arbitrary direction.

In a calculation using the second calculation data model, assuming that in the equation of continuum (Equation (25)) that expresses the mass conservation law of aggregated domains, the area of a boundary surface between aggregated control points of aggregated domains is equivalent in either case of viewing from the aggregated control point A side, or of viewing from the control point B side, the mass flux between the aggregated control points has a reversed plus or minus sign on either side of the aggregated control point A or the aggregated control point B, and has an equivalent absolute value. Therefore, taking the total sum of Equation (25) with respect to all the aggregated domains in the analysis domain, the mass flux between aggregated domains is canceled to be zero, which means that with respect to the entire analysis domain to be calculated, the mass flowing in is equivalent to the mass flowing out.

Therefore, in order to satisfy the mass conservation law with respect to the entire analysis domain to be calculated, it is necessary to satisfy a condition that the area of a boundary surface between two control points of aggregated domains is equivalent for the aggregated domains; and a condition that a normal vector of the boundary surface has a reversed plus or minus sign in either case of viewing from the control point on one side, or of viewing from the control point on the other side, and has an equivalent absolute value.

Further, in order to satisfy the mass conservation law, it is necessary to satisfy a condition that the total sum of the volumes occupied by the control volumes of aggregated domains is equivalent to the total volume Vₜₒₜₐₗ of the entire analysis domain as expressed in the following Equation (34), where ND represents the total number of aggregated domains in the analysis domain.

$${V}_{total} = {\sum }_{A = 1}^{ND} {V}_{A} \qquad ( 34 )$$

Note that here, although it has been described with respect to the equation of mass conservation, the conservation law must also be satisfied with respect to the momentum and the energy of a continuum. In order to satisfy the conservation law for these physical quantities by taking the total sum with respect to all the aggregated control points, it is understood that it is necessary to satisfy a condition that the volume occupied by the aggregated control volumes of all the aggregated control points is equivalent to the total volume of the entire analysis domain; a condition that the area of a boundary surface between two aggregated control points is equivalent for the two control points; and a condition that each second normal vector has an equivalent absolute value (with the sign of plus or minus reversed) in either case of viewing from the control point on one side, or of viewing from the control point on the other side.

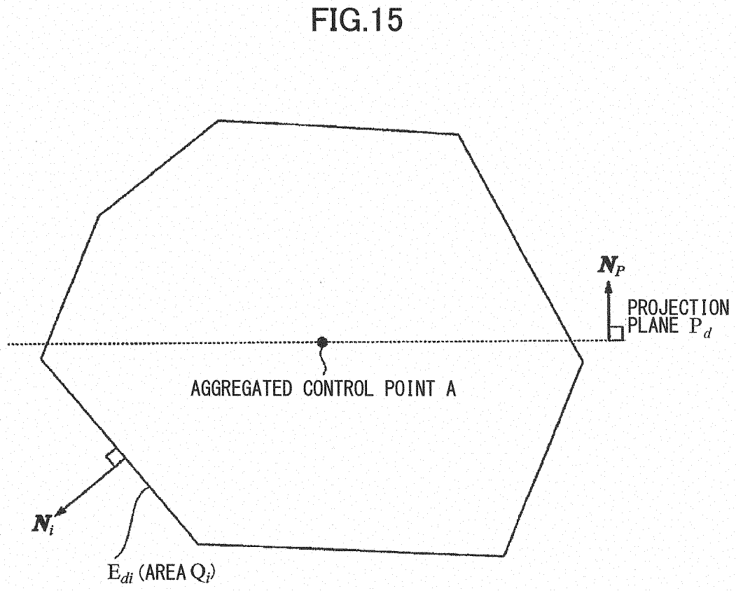

Further, in order to satisfy the conservation law, as illustrated in FIG. 15, considering an aggregated control volume occupied by an aggregated control point A, a condition is necessary that the following Equation (35) is satisfied considering an infinitely large projection plane P_{d} that passes through the aggregated control point A, and has a second unit normal vector [N]ₚ directed in an arbitrary direction. The second unit normal vector is a second normal vector having a unit length.

$${\sum }_{i = 1}^{m} [ ( {N}_{i} \cdot {N}_{p} ) \cdot {Q}_{i} ] = 0 \qquad ( 35 )$$

where in Equation (35), Qᵢ represents the area of the boundary surface E_{di} of one of the domains; [N]ᵢ represents the second unit normal vector of the boundary surface E_{di}; M represents the total number of surfaces of the aggregated control volume; and the subscript i represents an integer ranging 1 to M.

Equation (35) expresses that a polyhedron constituting an aggregated control volume constitutes a closure space. This Equation (35) is satisfied even if a part of the polyhedron constituting the aggregated control volume is dented.

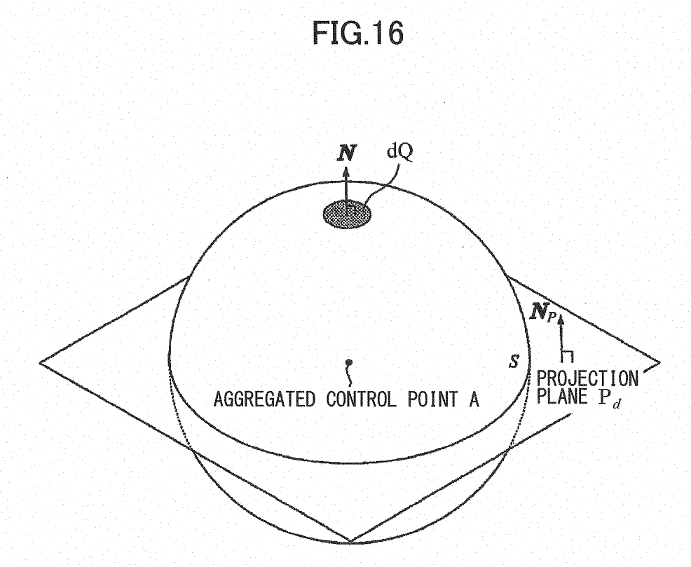

Also, taking one surface of the polyhedron as a minute face dQ, and taking the limit of M to infinity, the following Equation (36) is obtained, and it is understood that a curved surface object as illustrated in FIG. 16 also constitutes a closure space.

∫_{Q}N·NₚdQ=0 (36)

The condition that Equation (35) is satisfied is a necessary condition to satisfy Gauss' divergence theorem and the generalized Green's theorem expressed as Equation (14).

Moreover, the generalized Green's theorem is a fundamental theorem for discretization of a continuum. Therefore, in the case of transforming a volume integral into a surface integral to be discretized according to Green's theorem, in order to satisfy the conservation law, the condition that Equation (35) is satisfied is indispensable.

As such, when executing a numerical analysis using the second calculation data model and the physical quantity calculation as described above, in order to satisfy the conservation law of a physical quantity, the following three conditions are necessary (referred to as the “conditions for the second calculation”, below).

(a2) The total sum of volumes of all aggregated domains is equivalent to the volume of the analysis domain.

(b2) The area of a boundary surface between two aggregated control points is equivalent for the two control points; and a second normal vector of the boundary surface an absolute value that is equivalent in either case of viewing from the aggregated control point on one side (one of the aggregated domains forming the boundary surface), or of viewing from the aggregated control point on the other side (the other of the aggregated domains forming the boundary surface).

(c2) Equation (35) as above is satisfied considering an infinitely large projection plane P_{d} having a second unit normal vector [N]ₚ that passes through an aggregated control point (passes through an aggregated domain), and has a second unit normal vector [N]ₚ directed in an arbitrary direction.

In other words, in order to satisfy the conservation law, it is necessary to generate the first and second calculation data models so as to satisfy these conditions. However, as described above, in the present numerical analysis method, when generating a calculation data model, it is possible to change a cell shape of a divided domain discretionarily, and by taking an aggregated sum of such divided domain cells, an aggregated domain is generated; therefore, it is possible to easily generate the first and second calculation data models so as to satisfy the above three conditions.

As such, in the present numerical analysis method, not only the first calculation data model, but also the second calculation data model having a smaller number of divisions of the analysis domain than the first calculation data model satisfy the conservation law. For this reason, the present numerical analysis method has a feature that the analysis precision does not become lower for a smaller number of divisions of an analysis domain.

Note that in the above description, although examples of calculation of the physical quantity have been described in which discretized governing equations derived based on a weighted residual method from the Navier-Stokes equation and the equation of continuum are used, the discretized governing equations that can be used in the present numerical analysis method are not limited to these.

In other words, any discretized governing equation can be used in the present numerical analysis method as long as it is derived from among various equations (the mass conservation equation, the equation for conservation of momentum, the equation for conservation of energy, the advection-diffusion equation, the wave equation, etc.) based on a weighted residual method, and is capable of calculating a physical quantity by using only quantities that do not require quantities that specify geometrical shapes.

Moreover, such features of the discretized governing equations enable so-called meshless calculation in which a mesh is not required, unlike the conventional finite element method or finite volume method. Further, even if quantities that specify geometrical shapes of the cells are used in the preprocess, there is no constraint on the mesh as imposed in the conventional finite element method, the finite volume method, and the voxel method; therefore, it is possible to reduce the workload accompanying generation of a calculation data model. Specifically, based on quantities that specify geometrical shapes by software based on the conventional finite element method, finite volume method, and the like, for each divided domain, the volume and a divided-domain characteristic quantity representing a characteristic with respect to each adjacent divided domain may be calculated.

In the present embodiment, it is possible to derive a discretized governing equation that uses only quantities that do not require quantities that specify geometrical shapes based on a weighted residual method, from among the mass conservation equation, the equation for conservation of momentum, the equation for conservation of energy, the advection-diffusion equation, the wave equation, and the like. For this reason, in the present numerical analysis method, it is possible to use other governing equations. In this regard, the reason is substantially the same as described in Patent document 1, and the description is omitted here.

Note that although Patent document 1 describes that it is possible to derive a discretized governing equation in the case where an analysis domain is divided by divided domains, it is also possible to derive a discretized governing equation similarly in the case where an analysis domain is divided by aggregated domains.

### Application Examples

In the following description, specific application examples will be described with respect to a numerical analysis method including a physical quantity calculation method according to the present embodiment; a numerical analysis program including a physical quantity calculation program according to the present embodiment; and a numerical analysis apparatus including a physical quantity calculation apparatus according to the present embodiment.

Also, in the following specific application examples, a case of obtaining the flow velocity of air in a cabin space of a motor vehicle by numerical analysis will be described.

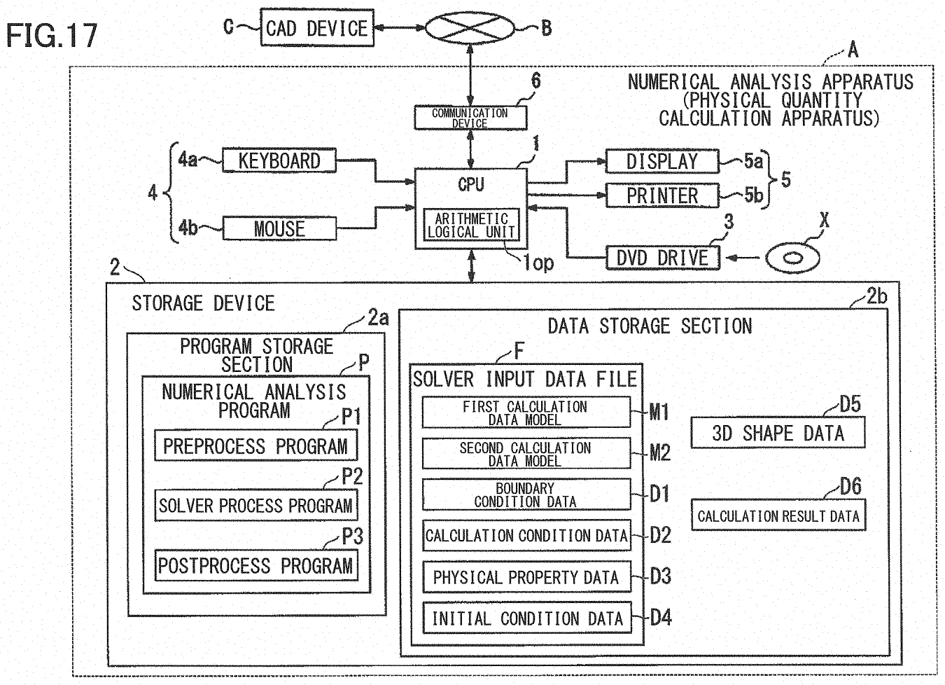

FIG. 17 is a block diagram schematically illustrating a hardware configuration of a numerical analysis apparatus A of the present embodiment.

As illustrated in this diagram, the numerical analysis apparatus A of the present embodiment is constituted with a computer, such as a personal computer, a workstation, or the like, that includes a CPU 1, a storage device 2, a DVD drive 3, input devices 4, output devices 5, and a communication device 6.

The CPU 1 is electrically connected to the storage device 2, the DVD drive 3, the input devices 4, the output devices 5, and the communication device 6, to process signals input from these various devices, and to output a processed result. Note that the CPU 1 is a specific example of an arithmetic/logical unit lop.

The storage device 2 is constituted with an internal storage device, such as a memory, and an external storage device, such as a hard disk drive, to store information input from the CPU 1 and to output stored information based on a command input from the CPU 1.

In addition, in the present embodiment, the storage device 2 includes a program storage section 2a and a data storage section 2b.

The program storage section 2a stores a numerical analysis program P. This numerical analysis program P is an application program to be executed on a predetermined OS (Operating System), to cause the numerical analysis apparatus A of the present embodiment constituted with a computer to function so as to execute numerical analysis. Then, by the arithmetic/logical unit lop executing the numerical analysis program P, each function of the numerical analysis apparatus A of the present embodiment is implemented.

Further, as illustrated in FIG. 17, the numerical analysis program P includes a preprocess program P1, a solver process program P2, and a postprocess program P3.

The preprocess program P1 causes the numerical analysis apparatus A of the present embodiment to execute a process (preprocess) prior to executing a solver process, and to function as a first calculation data model generator so as to generate a first calculation data model. Also, the preprocess program P1 causes the numerical analysis apparatus A of the present embodiment to function as a second calculation data model generator so as to generate a second calculation data model. Also, the preprocess program P1 causes the numerical analysis apparatus A of the present embodiment to set conditions required for executing the solver process, and further, to generate a solver input data file F in which the above calculation data models and the set conditions are put together. Note that the preprocess program P1 causes the numerical analysis apparatus A of the present embodiment to function as the first calculation data model generator, and after having generated a first calculation data model, causes the numerical analysis apparatus A of the present embodiment to function as the second calculation data model generator.

In the case of causing the numerical analysis apparatus A of the present embodiment to function as the first calculation data model generator and the second calculation data model generator, the preprocess program P1 first causes the numerical analysis apparatus A of the present embodiment to obtain three-dimensional shape data including a cabin space of a motor vehicle, and to generate an analysis domain representing the cabin space of the motor vehicle included in the obtained three-dimensional shape data.

Note that as will be described later in detail, in the present embodiment, in the solver process, the discretized governing equations described in the above numerical analysis method using the present embodiment are used. The discretized governing equations described in the above numerical analysis method using the present embodiment are, specifically, discretized governing equations that use only quantities that do not require quantities that specify geometrical shapes, and are derived based on a weighted residual method. Because of this, when generating the first calculation data model and the second calculation data model, it is possible to discretionarily change the shapes of divided domains, the shapes of aggregated domains based on the divided domains, and the shape of the analysis domain under the conditions satisfying the conservation law. Therefore, simple work would be sufficient for modifying or changing the cabin space of the motor vehicle included in the three-dimensional shape data. Thereupon, in the present embodiment, the preprocess program P1 causes the numerical analysis apparatus A of the present embodiment to execute a process of mending holes and gaps existing in the cabin space of the motor vehicle that is included in the obtained three-dimensional shape data, by a wrapping process with minute closed surfaces.

Thereafter, the preprocess program P1 causes the numerical analysis apparatus A of the present embodiment to form divided domains as has been described in the process of dividing into multiple divided domains, and to generate an analysis domain including the entire cabin space mended by the wrapping process and the like. Next, the preprocess program P1 causes the numerical analysis apparatus A of the present embodiment to cut out a domain protruding from the cabin space among the generated divided domains, so as to generate an analysis domain that represents the cabin space. Here again, since the above discretized governing equations are used in the solver process, it is possible to easily cut a domain protruding from the cabin space in the analysis domain.

Thereby, the boundary with the external space does not become a staircase shape as in the voxel method, and when generating the analysis domain around the boundary with the external space, there is no need for special modifications or processes involving a tremendous amount of manual work requiring experiences and/or trial and error as needed in the cut-cell method of the voxel method. For this reason, in the present embodiment, there is no problem related to processing the boundary with the external space, which has been a problem in the voxel method.

Note that in the present embodiment, as will be described later, by filling a gap between the cabin space and a cut domain with a new discretionarily-shaped divided domain, the analysis domain becomes constituted with divided domains not dependent only on orthogonal grid shapes, and in addition, the analysis domain is filled with divided domains without overlapping.

Next, in the case of causing the numerical analysis apparatus A of the present embodiment to function as the first calculation data model generator, the preprocess program P1 causes the numerical analysis apparatus A of the present embodiment to execute a process of arranging one control point in the inside of each divided domain included in the analysis domain representing the generated cabin space, and to store the arrangement information on the control points, and the volume data of the control volumes occupied by the respective control points.

In addition, in the case of causing the numerical analysis apparatus A of the present embodiment to function as the first calculation data model generator, the preprocess program P1 causes the numerical analysis apparatus A of the present embodiment to calculate the area and the first normal vector for each boundary surface as the boundary surface between the divided domains, and to store the area and the first normal vector of each of these boundary surfaces.

Further, in the case of causing the numerical analysis apparatus A of the present embodiment to function as the first calculation data model generator, the preprocess program P1 causes the numerical analysis apparatus A to generate linkage information on the control volumes or control points (links), and to store the links.

Then, the preprocess program P1 causes the numerical analysis apparatus A of the present embodiment to put together the volume of the control volume occupied by each control point; the area and first normal vector of each boundary surface; the arrangement information on the control points that represents the arrangement information on the divided domains; and the links, so as to generate the first calculation data model. The arrangement represented in the arrangement information may be represented, for example, by using coordinates.

In the case of causing the numerical analysis apparatus A of the present embodiment to function as the second calculation data model generator, the preprocess program P1 causes the numerical analysis apparatus A of the present embodiment to aggregate control volumes (cells) by the method illustrated in FIG. 7 or FIG. 8 by using the generated first calculation data model, so as to generate aggregated domains in the analysis domain that represents the cabin space.

Next, in the case of causing the numerical analysis apparatus A of the present embodiment to function as the second calculation data model generator, the preprocess program P1 causes the numerical analysis apparatus A of the present embodiment to virtually arrange one aggregated control point in the inside of each aggregated domain included in the analysis domain that represents the generate cabin space, and to store the arrangement information on the aggregated control points and the volume data of the domains having the respective aggregated control points arranged.

In the process of virtually arranging the above aggregated control points, the preprocess program P1 causes the numerical analysis apparatus A of the present embodiment to execute an aggregated control point calculation process, so as to obtain information that represents locations at which the respective aggregated control points are arranged. The aggregated control point calculation process is a process executed by the numerical analysis apparatus A of the present embodiment to obtain the volumes of the control volumes and the arrangement information on the control points included in the first calculation data model, and to calculate locations at which the respective aggregated control points are arranged by executing calculation according to Equation (20) and Equation (21).

Also, in the case of causing the numerical analysis apparatus A of the present embodiment to function as the second calculation data model generator, the preprocess program P1 causes the numerical analysis apparatus A of the present embodiment to calculate the area and the second normal vector of the boundary surface between the above aggregated domains (referred to as the “calculation process of boundary-surface characteristic quantities of aggregated domains”, below), and to store the areas and the second normal vectors of these boundary surfaces.

The calculation process of boundary-surface characteristic quantities of aggregated domains is a process executed by the numerical analysis apparatus A of the present embodiment to obtain the information on the areas of the boundary surfaces and the first normal vectors included in the first calculation data model, and to execute a calculation according to Equation (22) and Equation (23) so as to calculate the area and second normal vector of each boundary surface between the aggregated domains.

Further, in the case of causing the numerical analysis apparatus A of the present embodiment to function as the second calculation data model generator, the preprocess program P1 causes the numerical analysis apparatus A to generate linkage information on the domains or aggregated control points (links), and to store the links.

Then, the preprocess program P1 causes the numerical analysis apparatus A of the present embodiment to put together the volumes of the domains having the control points arranged; the area and second normal vector of each boundary surface; the arrangement information on the aggregated control points that represents the arrangement information on the aggregated domains; and the links, so as to generate the second calculation data model. The arrangement represented in the arrangement information may be represented, for example, by using coordinates.

Also, in the case of setting conditions required for executing the solver process described above, the preprocess program P1 causes the numerical analysis apparatus A of the present embodiment to execute settings of physical properties, settings of boundary conditions, settings of initial conditions, and settings of calculation conditions.

Here, the physical properties include the density, viscous coefficient, and the like of the air in the cabin space.

The boundary conditions are conditions that specify laws of exchange of physical quantities between control points, which are, as have been described above in the present embodiment, the discretized governing equation based on the Navier-Stokes equation expressed as Equation (10) and the discretized governing equation based on the equation of continuum expressed as Equation (11).

The boundary conditions also include information that represents aggregated domains that face the boundary surface between the cabin space and the external space.

The initial conditions represent physical quantities at the outset of executing the solver process, which are initial values of the flow velocity in the respective divided domains and aggregated domain.

The calculation conditions are conditions of calculation in the solver process, for example, the number of repetitions and convergence criteria.

Also, the preprocess program P1 causes the numerical analysis apparatus A of the present embodiment to form a GUI (Graphical User Interface). More specifically, the preprocess program P1 causes the display 5a of the output device 5 to display graphics, and transitions into a state in which operations with the keyboard 4a and the mouse 4b of the input device 4 are enabled.

The solver process program P2 (physical quantity calculation program) is a program that causes the numerical analysis apparatus A of the present embodiment to execute the solver process, and causes the numerical analysis apparatus A of the present embodiment to function as a physical quantity calculation apparatus.

Then, in the case of causing the numerical analysis apparatus A of the present embodiment to function as a physical quantity calculator, the solver process program P2 causes the physical quantity calculator to use the solver data file F to calculate physical quantities in the analysis domain.

In addition, in the case of causing the numerical analysis apparatus A of the present embodiment to function as the physical quantity calculator, the solver process program P2 causes the numerical analysis apparatus A of the present embodiment to generate a discretized coefficient matrix of the Navier-Stokes equation and the equation of continuum included in the solver data file F, and to generate a data table for forming a matrix.

Also, in the case of causing the numerical analysis apparatus A of the present embodiment to function as the physical quantity calculator, the solver process program P2 causes the numerical analysis apparatus A of the present embodiment to set up a large-scale sparse matrix equation for matrix calculation expressed as the following Equation (37), from the discretized governing equation expressed as Equation (29) described above based on the Navier-Stokes equation and the discretized governing equation expressed as Equation (30) described above based on the equation of continuum.

Note that the solver processing program P2 can, not only execute a numerical calculation that takes as input the second calculation data model generated from the aggregated domains, but also execute a numerical calculation that takes as input the first calculation data model generated from the divided domains. In the latter case, the solver process program P2 causes the numerical analysis apparatus A of the present embodiment to set up a large-scale sparse matrix equation for matrix calculation expressed as the following Equation (37), from the discretized governing equation expressed as Equation (10) described above based on the Navier-Stokes equation and the discretized governing equation expressed as Equation (11) described above based on the equation of continuum.

A·X=B (37)

where in Equation (37), [A] represents a large-scale sparse matrix, [B] represents a boundary condition vector, and [X] represents the flow velocity as a solution.

In addition, in the case where there is a supplementary condition such as incompressibility in the above discretized governing equation, the solver process program P2 causes the numerical analysis apparatus A of the present embodiment to incorporate this supplementary condition into the matrix equation.

Then, the solver process program P2 causes the numerical analysis apparatus A of the present embodiment to calculate a solution of the matrix equation by the CG method (conjugate gradient method) or the like, to update the solution by using the following Equation (38), to execute a determination on the convergence condition, and to obtain a final calculation result.

A(Xⁿ)·Xⁿ⁺¹=B(Xⁿ) (38)

The postprocess program P3 is a program that causes the numerical analysis apparatus A of the present embodiment to execute a postprocess, and causes the numerical analysis apparatus A of the present embodiment to execute a process based on a calculation result obtained in the solver process.

More specifically, the postprocess program P3 causes the numerical analysis apparatus A of the present embodiment to execute a visualization process and an extraction process with respect to a calculation result.

Here, the visualization process is a process of causing the output device 5 to output, for example, a cross-sectional contour display, a vector display, an isosurface display, and an animation display. Also, the extraction process is a process of extracting quantitative values in domains specified by the operator to be output on the output device 5 as numerical values and/or graphs, or of extracting quantitative values in domains specified by the operator to be output as a file.

The postprocess program P3 also causes the numerical analysis apparatus A of the present embodiment to execute automatic report generation, display of calculated residuals, and analysis.

As illustrated in FIG. 17, the data storage section 2b is a section that stores the first calculation data model M1; the second calculation data model M2; boundary condition data D1 representing the boundary conditions; calculation condition data D2 representing the calculation conditions; physical property data D3 representing the physical properties; the solver input data file F including initial condition data D4 representing the initial conditions; three-dimensional shape data D5; calculation result data D6; and the like. In addition, the data storage section 2b temporarily stores intermediate data generated during the course of processing executed by the CPU 1.

The DVD drive 3 is a drive that is configured to be capable of taking in a DVD medium X, and based on a command input from the CPU 1, outputs data to be stored in the DVD medium X. Further, in the present embodiment, the numerical analysis program P is stored in the DVD medium X, and the DVD drive 3 outputs the numerical analysis program P stored in the DVD medium X based on a command input from the CPU 1.

The input device 4 is a human-machine interface between the numerical analysis apparatus A of the present embodiment and the operator, and includes the keyboard 4a and the mouse 4b as pointing devices.

The output device 5 is a device to visualize and output signals input from the CPU 1, and includes the display 5a and the printer 5b.

The communication device 6 exchanges data between the numerical analysis apparatus A of the present embodiment and an external device such as a CAD device C, and is electrically connected to a network B such as an in-house LAN (Local Area Network).

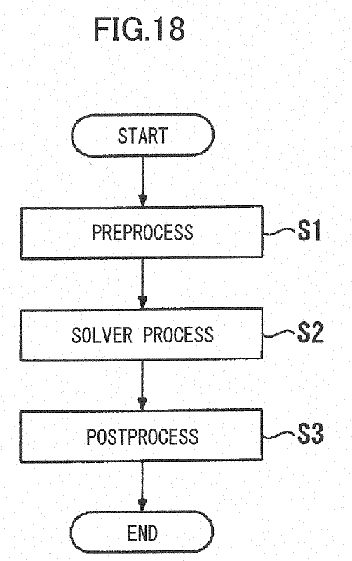

Next, a numerical analysis method using the numerical analysis apparatus A of the present embodiment configured as such (numerical analysis method of the present embodiment) will be described with reference to flowcharts in FIG. 18 to FIG. 20.

As illustrated in the flowchart in FIG. 18, the numerical analysis method of the present embodiment includes a preprocess (Step S1), a solver process (Step S2), and a postprocess (Step S3).

Note that before executing the numerical analysis method of the present embodiment, the CPU 1 extracts from the DVD medium X the numerical analysis program P stored in the DVD medium X taken into the DVD drive 3, and stores it in the program storage section 2a of the storage device 2.

Then, when a signal instructing to start numerical analysis is input from the input device 4, the CPU 1 executes the numerical analysis based on the numerical analysis program P stored in the storage device 2. More specifically, the CPU 1 executes the preprocess (Step S1) based on the preprocess program P1 stored in the program storage section 2a; executes the solver process (Step S2) based on the solver process program P2 stored in the program storage section 2a; and executes the postprocess (Step S3) based on the postprocess program P3 stored in the program storage section 2a. Note that the CPU 1 executing the preprocess (Step S1) based on the preprocess program P1 causes the numerical analysis apparatus A of the present embodiment to function as a calculation data model generator. Also, the CPU 1 executing the solver process (Step S2) based on the solver process program P2 causes the numerical analysis apparatus A of the present embodiment to function as a physical quantity calculator.

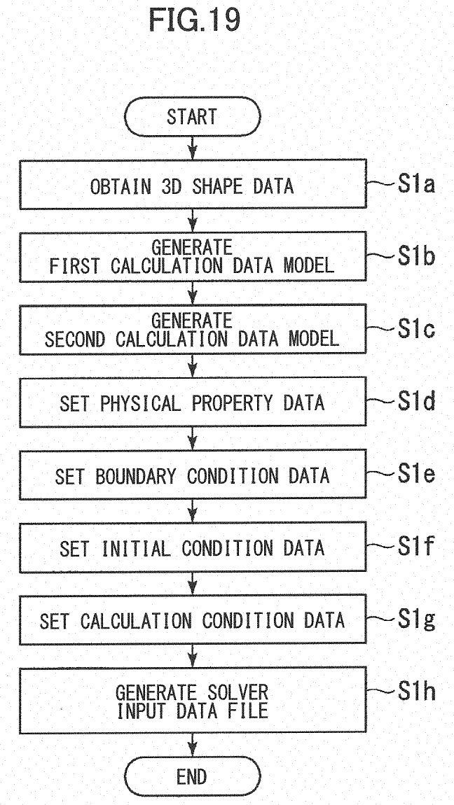

FIG. 19 is a flowchart illustrating the preprocess (Step S1). As illustrated in this figure, once the preprocess (Step S1) has been started, the CPU 1 causes the communication device 6 to obtain the three-dimensional shape data D5 including the cabin space of the motor vehicle from the CAD device C via the network B (Step S1a). The CPU 1 causes the data storage section 2b of the storage device 2 to store the obtained three-dimensional shape data D5.

Next, the CPU 1 generates a first calculation data model based on the three-dimensional shape data D5 obtained at Step S1a (Step S1b).

Specifically, the CPU 1 virtually arranges one control point in each divided domain included in the analysis domain that represents the cabin space. Here, the CPU 1 calculates the center of gravity for the divided domain, to virtually arrange one control point at each center of gravity. Then, the CPU 1 calculates the arrangement information on the control points, the volume of the control volume occupied by each control point (the volume of the divided domain having the control point arranged), and causes the data storage section 2b of the storage device 2 to temporarily store the calculated data.

The CPU 1 also calculates the area and the first normal vector of each boundary surface as the boundary surface between the divided domains, and causes the data storage section 2b of the storage device 2 to temporarily store the areas and the first normal vectors of these boundary surfaces.

The CPU 1 also generates links between the divided domains, and causes the data storage section 2b of the storage device 2 to temporarily store the links between the divided domains.

Then, the CPU 1 generates a database from the arrangement information on the control points, the volume of the control volume occupied by each control point, the area and the normal vector of each boundary surface, and the links stored in the data storage section 2b to generate the first calculation data model, and causes the data storage section 2b of the storage device 2 to store the generated first calculation data model.

Further, in the present embodiment, at Step S1b, a configuration is adopted in which divided domains are formed first, and then, control points are arranged, and for each of the control points, the volume of the divided domain having the control point arranged is assigned.

However, in the present embodiment, it is also possible to arrange the control points in the analysis domain first, and then, to assign the volume to each of the control points.

Specifically, for example, each control point is given a weight based on a radius reaching a different control point or a distance to a control point in a linkage relationship (associated with a link).

Here, denoting the weight of a control point i by wᵢ and the reference volume by V⁺, the volume Vᵢ assigned to the control point i is expressed as in the following Equation (39).

Vᵢ=wᵢ·V⁺ (39)

Further, since the total sum of the volumes Vᵢ of the control points is equivalent to the volume Vₜₒₜₐₗ of the analysis domain, the following Equation (40) is satisfied.

$${\sum }_{i} {V}_{i} = {V}^{+} \cdot {\sum }_{i} {w}_{i} = {V}_{total} \qquad ( 40 )$$

Consequently, it is possible to obtain the reference volume V⁺ by the following Equation (41).

$${V}^{+} = {V}_{total} \text{/} {\sum }_{i} {w}_{i} \qquad ( 41 )$$

Therefore, the volume assigned to each control point can be obtained from Equations (40) and (41).

By using such a method in the preprocess, without using quantities that specify geometrical shapes, it is possible to obtain the volumes of the divided domains to be held in the first calculation data model.

Further, in the generation of the first calculation data model (Step S1b), the CPU 1 forms a GUI, and when a command (for example, a command to specify the density of the divided domains or a command to specify the shapes of the divided domains) is input from the GUI, executes a process reflecting the command. Therefore, the operator can discretionarily adjust the arrangement of the control points and the shapes of the divided domains by operating the GUI.

However, upon collation with the three conditions for satisfying the conservation law stored in the numerical analysis program, if the command input from the GUI deviates from the conditions, the CPU 1 causes the display 5a to display a message indicating the deviation.

Next, the CPU 1 generates a second calculation data model based on the first calculation data model generated at Step S1b (Step S1c).

Specifically, by using the generated first calculation data model, the CPU 1 aggregates control volumes (cells) by the method illustrated in FIG. 7 or FIG. 8 to generate aggregated domains in the analysis domain that represents the cabin space. Next, the CPU 1 virtually arranges one aggregated control point in each aggregated domain included in the analysis domain that represents the cabin space. Here, based on the first calculation data model, the CPU 1 calculates aggregated control points by Equation (20) and (21), and virtually arranges one aggregated control point in each aggregated domain. Then, the CPU 1 calculates arrangement information on the aggregated control points, and the volume of the aggregated control volume occupied by each aggregated control point (the volume of an aggregated domain having an aggregated control point arranged), and causes the data storage section 2b of the storage device 2 to store them temporarily.

The CPU 1 also calculates the area and the second normal vector of each boundary surface as the boundary surface of the aggregated domains, and causes the data storage section 2b of the storage device 2 to store these areas and second normal vectors of the boundary surface temporarily.

Also, the CPU 1 generates links of the aggregated domains and causes the data storage section 2b of the storage device 2 to store the links of the aggregated domains temporarily.

Then, the CPU 1 generates a database from the arrangement information on the aggregated control points, the volume of the aggregated domain having each aggregated control point, the area and the second normal vector of each boundary surface, and the links stored in the data storage section 2b to generate the second calculation data model, and causes the data storage section 2b of the storage device 2 to store the generated second calculation data model.

Also, in the generation of the second calculation data model (Step S1c), the CPU 1 forms a GUI, and when a command (for example, a command to specify the density of the divided domains or a command to specify the shapes of the divided domains) is input from the GUI, executes a process reflecting the command. Therefore, the operator can discretionarily adjust the arrangement of the aggregated control points and the shapes of the aggregated domains by operating the GUI. Note that since an aggregated domain is merely a collection of control volumes (cells), the shapes of an aggregated domain cannot be changed while ignoring the control volumes (cells).

However, upon collation with the three conditions for satisfying the conservation law stored in the numerical analysis program, if the command input from the GUI deviates from the conditions, the CPU 1 causes the display 5a to display a message indicating the deviation.

Next, the CPU 1 sets physical property data (Step S1d). Specifically, the CPU 1 displays an input screen of physical properties on the display 5a by using the GUI, and causes the data storage section 2b to temporarily store signals representing the physical properties input from the keyboard 4a or the mouse 4b as the physical property data D3, to set the physical properties. Note that the physical properties mentioned here are characteristic values of the air as the fluid in the cabin space, which may include the density, viscosity coefficient, and the like of the air.

Next, the CPU 1 sets boundary condition data (Step S1e). Specifically, the CPU 1 displays an input screen of boundary conditions on the display 5a by using the GUI, and causes the data storage section 2b to temporarily store signals representing the boundary conditions input from the keyboard 4a or the mouse 4b as the boundary condition data D1, to set the boundary condition data. Note that the boundary conditions mentioned here represent a discretized governing equation that dominates a physical phenomenon in the cabin space, identification information on aggregated control points facing the boundary surface between the cabin space and the external space, and a heat transfer condition between the cabin space and the external space, and the like.

Note that since the numerical analysis method of the present embodiment aims at obtaining the flow velocity in the cabin space by numerical analysis, as the discretized governing equations, the discretized governing equation (29) based on the Navier-Stokes equation and the discretized governing equation (30) based on the equation of continuum as described above are used.

Note that these discretized governing equations are selected, for example, from among multiple discretized governing equations stored in advance in the numerical analysis program P and displayed on the display 5a, by the operator using the keyboard 4a and the mouse 4b.

Next, the CPU 1 sets initial condition data (Step S1f). Specifically, the CPU 1 displays an input screen of initial conditions on the display 5a by using the GUI, and causes the data storage section 2b to temporarily store signals representing the initial conditions input from the keyboard 4a or the mouse 4b as the initial condition data D4, to set the initial condition data. Note that the initial conditions mentioned here include the initial flow velocity at each control point (each divided domain) and the initial flow velocity at each aggregated control point (each aggregated domain).

Next, the CPU 1 sets calculation condition data (Step S1g). Specifically, the CPU 1 displays an input screen of calculation conditions on the display 5a by using the GUI, and causes the data storage section 2b to temporarily store signals representing the calculation conditions input from the keyboard 4a or the mouse 4b as the calculation condition data D2, to set the calculation condition data. Note that the calculation conditions mentioned here are conditions of calculation in the solver process (Step S2), for example, the number of repetitions and convergence criteria.

Next, the CPU 1 generates a solver input data file F (Step S1h).

Specifically, the CPU 1 stores the first calculation data model M1 generated at Step S1b; the second calculation data model M2 generated at Step S1c; the physical property data D3 set at Step S1d; the boundary condition data D1 set at Step S1e; the initial condition data D4 set at Step S1f; and the calculation condition data D2 set at Step S1g, in the solver input data file F, to generate the solver input data file F. Note that this solver input data file F is stored in the data storage section 2b.

Upon completion of the preprocess (Step S1) as described above, the CPU 1 executes the solver process (Step S2) illustrated in the flowchart in FIG. 18, based on the solver process program P2.

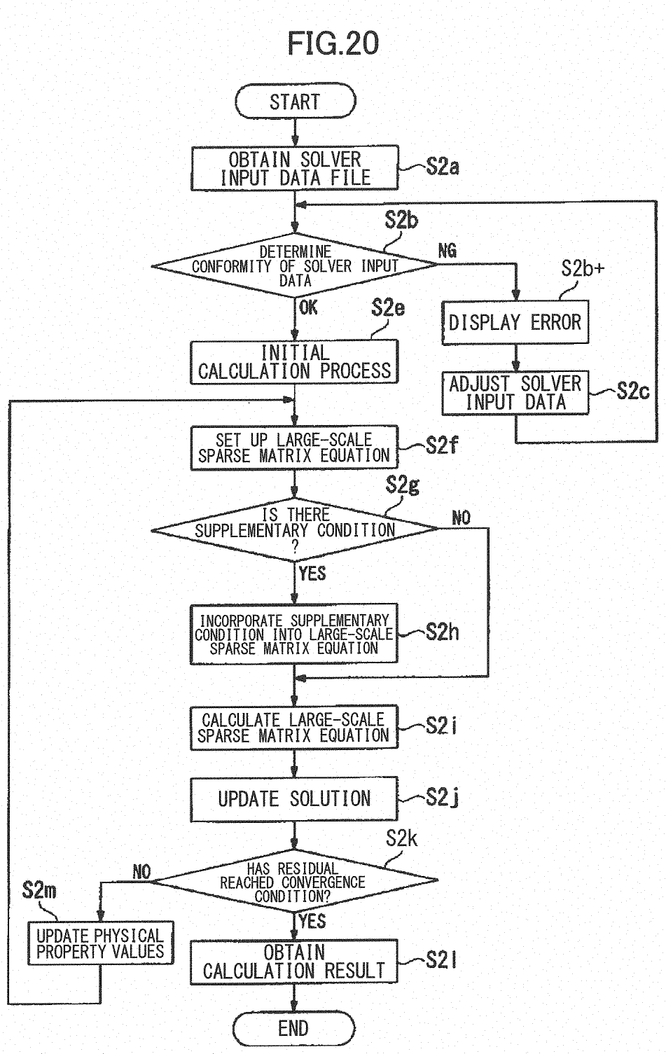

As illustrated in FIG. 20, once the solver process (Step S2) has been started, the CPU 1 obtains the solver input data file F generated in the preprocess (Step S1) (Step S2a). Note that as in the numerical analysis method described in the present embodiment, in the case of executing the preprocess and the solver process on a single apparatus (the numerical analysis apparatus A of the present embodiment), since the solver input data file F is stored in the data storage section 2b, Step S2a can be skipped. However, in the case of executing the preprocess (Step S1) and the solver process (Step S2) on different apparatuses, since it is necessary to obtain the solver input data file F transmitted through the network or the removable disk, Step S2a needs to be executed.

Next, the CPU 1 determines the consistency of the solver input data (Step S2b). Note that the solver input data means data stored in the solver input data file F, which includes the first calculation data model M1; the second calculation data model M2; the boundary condition data D1; the calculation condition data D2; the physical property data D3; and the initial condition data D4.

Specifically, the CPU 1 analyzes whether the solver input data that enables to execute the physical quantity calculation in the solver process is stored in the solver input data file F, to determine the consistency of the solver input data.

Then, if having determined that the solver input data is inconsistent, the CPU 1 causes the display 5a to display an error (Step S2b+), and further, to display a screen for inputting data to compensate for the inconsistent part. Thereafter, the CPU 1 adjusts the solver input data based on signals input from the GUI (Step S2c), to execute Step S2a again.

On the other hand, if having determined at Step S2b that the solver input data is consistent, the CPU 1 executes an initial calculation process (Step S2e).

Specifically, the CPU 1 generates a discretized coefficient matrix from the discretized governing equations stored in the boundary condition data D1, and further, generates a data table for matrix calculation, to execute the initial calculation process. Note that the discretized governing equations stored in the boundary condition data D1 are, for example, the discretized governing equation (29) based on the Navier-Stokes equation and the discretized governing equation (30) based on the equation of continuum.

Note that in the case of executing a numerical calculation in which the first calculation data model generated from the divided domains is taken as the solver input data, the CPU 1 generates a discretized coefficient matrix from the discretized governing equations stored in the boundary condition data D1, and further, generates a data table for matrix calculation, to execute the initial calculation process. Note that the discretized governing equations stored in the boundary condition data D1 are, for example, the discretized governing equation (10) based on the Navier-Stokes equation and the discretized governing equation (11) based on the equation of continuum.

Next, the CPU 1 sets up a large-scale sparse matrix equation (Step S2f). Specifically, the CPU 1 sets up a large-scale sparse matrix equation for matrix calculation expressed as Equation (37) described above, from the discretized governing equation (29) based on the Navier-Stokes equation and the discretized governing equation (30) based on the equation of continuum.

Note that in the case of executing a numerical calculation in which the first calculation data model generated from the divided domains is taken as the solver input data, the CPU 1 sets up a large-scale sparse matrix equation for matrix calculation expressed as Equation (37) described above, from the discretized governing equation (10) based on the Navier-Stokes equation and the discretized governing equation (11) based on the equation of continuum.

Next, the CPU 1 determines whether there is a supplementary condition such as incompressibility or contact in the discretized governing equation. This supplementary condition is stored, for example, in the solver input data file F as a boundary condition data item.

Then, if having determined that there is a supplementary condition in the discretized governing equation, the CPU 1 incorporates the supplementary condition into the large-scale matrix equation(Step S2h), and then, calculates the large-scale matrix equation (Step S2i). On the other hand, if having determined that there is no supplementary condition in the discretized governing equation, without incorporating any supplementary condition into the large-scale matrix equation(Step S2h), the CPU 1 calculates the large-scale matrix equation (Step S2i).

Then, the CPU 1 solves the large-scale matrix equation by, for example, the CG method (conjugate gradient method), and updates the solution (Step S2j) by using Equation (38) described above.

Next, the CPU 1 determines whether or not the residual of Equation (38) has reached the convergence condition (Step S2k). Specifically, the CPU 1 calculates the residual of Equation (38), compares it with the convergence condition included in the calculation condition data D2, and thereby, determines whether or not the residual of Equation (38) has reached the convergence condition.

Then, if having determined that the residual has not reached the convergence condition, the CPU 1 updates the physical properties, and then, executes the Step S2g again. In other words, the CPU 1 repeats Steps S2f to S2k until the residual of Equation (38) reaches the convergence condition while updating the physical properties.

On the other hand, if having determined that the residual has reached the convergence condition, the CPU 1 obtains the calculation result (Step S21). Specifically, the CPU 1 causes the data storage section 2b to store a solution of physical quantities calculated at the preceding Step S2i as the calculation result data, to obtain the calculation result.

The flow velocity of the air in the cabin space is obtained by the solver process as such (Step S2). Note that the solver process as such (Step S2) corresponds to the physical quantity calculation method of the present embodiment.

Upon completion of the solver process (Step S2) as described above, the CPU 1 executes a postprocess (Step S3) based on the postprocess program P3.

Specifically, for example, the CPU 1 generates cross-sectional contour data, vector data, isosurface data, and/or animation data from the calculation result data based on a command input from the GUI, and causes the output device 5 to visualize the data.

Also, based on a command input from the GUI, the CPU 1 extracts quantitative values (calculation result) in a part of the cabin space to generate numerical values and/or graphs, to cause the output device 5 to visualize the numerical values and/or graphs, and further, outputs the numerical values and/or graphs collectively as a file. Also, based on a command input from the GUI, the CPU 1 executes automatic report generation, display of calculated residuals, and analysis from the calculation result data, to output the result.

Furthermore, in the case where the user of the numerical analysis apparatus A, the numerical analysis method, and the numerical analysis program of the present embodiment changes the three-dimensional shape data depending on a result of the postprocess to repeat the process in the flowchart in FIG. 18 again, it is possible to calculate the physical quantity within a practical time.

In other words, by evaluating calculation result data obtained by the postprocess, if the user determines that a desired result has been obtained with the three-dimensional shape data to be analyzed, the user may end the simulation. Alternatively, by evaluating calculation result data obtained by the postprocess, if the user determines that a desired result has not been obtained with the three-dimensional shape data to be analyzed, the user may modify the three-dimensional shape data, to execute the simulation again.

In the above operations, if the simulation exhibits a desired result, the user may determine that the design of a physical entity (e.g., the inside of a cabin of a motor vehicle, a cockpit, a residence, an electric device, an industrial device, a manufacturing device of glass, steel, etc., or anything that constitutes a closed space) represented by the three-dimensional shape data to be analyzed is satisfactory, and may proceed to manufacture and/or produce the physical entity. On the other hand, if the simulation does not exhibit a desired result, the user may determine that the design of a physical entity represented by the three-dimensional shape data to be analyzed is not satisfactory, and may proceed to change the design of the physical entity, to execute the simulation again based on the three-dimensional shape data after the design change.

According to the numerical analysis apparatus A, the numerical analysis method, and the numerical analysis program of the present embodiment as described above, in the preprocess, the second calculation data model M2 having the volume of each aggregated control volume and the area and the second normal vector of each boundary surface is generated; and in the solver process, by using the volume of each aggregated control volume and the area and the second normal vector of each boundary surface included in the second calculation data model M2, the physical quantity in each of the aggregated control volumes is calculated.

In this way, by using the numerical analysis method of the present embodiment, the physical quantity can be calculated. For this reason, the numerical analysis method of the present embodiment is a method of analyzing a physical phenomenon that numerically analyzes the physical phenomenon.

Note that the numerical analysis apparatus A, the numerical analysis method, and the numerical analysis program of the present embodiment fill an analysis domain with divided domains that do not overlap each other. Because of this, the six conditions (a1) to (c1) and (a2) to (c2) for satisfying the conservation law are satisfied, and thereby, the flow velocity can be calculated while satisfying the conservation law.

The numerical analysis apparatus A of the present embodiment configured in this way generates a calculation data model that does not have quantities that specify geometrical shapes and satisfies the conservation law; therefore, it is possible to make a reduced calculation load in the solver process thanks to a reduced number of divisions of an analysis domain, compatible with prevention of a decreased analysis precision due to the reduced number of divisions of the analysis domain.

Further, according to the numerical analysis apparatus A, the numerical analysis method, and the numerical analysis program of the present embodiment, as described above, it is possible to significantly reduce the workload on the first and second calculation data models in the preprocess, and to reduce the calculation load in the solver process.

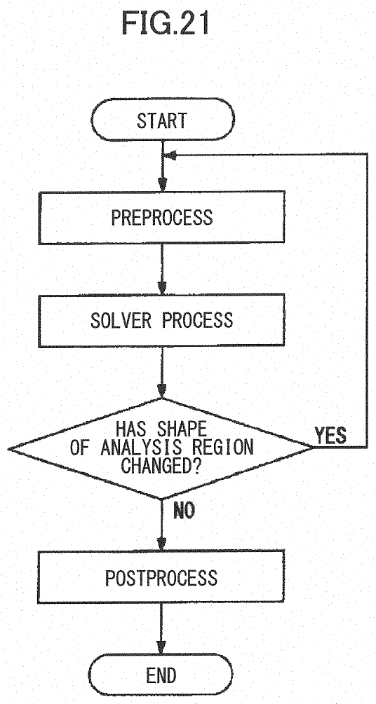

Therefore, even when the analysis domain includes a moving boundary and the shape of the analysis domain changes in a time series, according to the present embodiment, as illustrated in the flowchart in FIG. 21, by repeating the preprocess and the solver process every time the shape of the analysis domain changes, it is possible to calculate the physical quantity within a practical time. Furthermore, in the case where the user of the numerical analysis apparatus A, the numerical analysis method, and the numerical analysis program of the present embodiment changes the three-dimensional shape data depending on a result of the postprocess, and repeats the process in the flowchart in FIG. 21 again, it is possible to calculate the physical quantity within a practical time.

In other words, by evaluating calculation result data obtained by the postprocess, if the user determines that a desired result has been obtained with the three-dimensional shape data to be analyzed, the user may end a simulation. Alternatively, by evaluating calculation result data obtained by the postprocess, if the user determines that a desired result has not been obtained with the three-dimensional shape data to be analyzed, the user may modify the three-dimensional shape data, to execute the simulation again.

In the above operations, when the simulation exhibits a desired result, the user may determine that the design of a physical entity (e.g., the inside of a cabin of a motor vehicle, a cockpit, a residence, an electric device, an industrial device, a manufacturing device of glass, steel, etc., or anything that constitutes a closed space) represented as the three-dimensional shape data to be analyzed is satisfactory, and may proceed to manufacture and/or produce the physical entity. On the other hand, if the simulation does not exhibit a desired result, the user may determine that the design of a physical entity represented as the three-dimensional shape data to be analyzed is not satisfactory, and may proceed to change the design of the physical entity, to execute the simulation again based on the three-dimensional shape data after the design change.

The moving boundary here is a boundary of an object that changes when the target object moves in an analysis domain. As a case where an analysis domain includes a moving boundary and the shape of the analysis domain changes in a time series, for example, a case of a cabin may be considered in which a phenomenon to be reproduced is a transition from a state of the cabin with no occupant to a state of the cabin with an occupant on board. As another case, a case of a heating furnace may be considered in which a phenomenon to be reproduced is a movement of an object to be heated in the heating furnace.

As above, although the preferred embodiments have been described above with reference to the accompanying drawings, it is needless to say that an embodiment is not limited to the embodiments described above. The shapes and combinations of the elements illustrated in the above embodiments are merely examples, and various modifications can be made based on design requirements and the like without departing from the gist of the embodiments.

In the above embodiments, a configuration has been described in which the air flow velocity is obtained by numerical analysis that uses the discretized governing equations derived from the Navier-Stokes equation as a modified example of the equation of momentum conservation, and the equation of continuum.

However, the present embodiment is not limited as such; a physical quantity may be calculated by numerical analysis using a discretized governing equation derived from at least any one of the mass conservation equation, the equation for conservation of momentum, the equation of conservation of angular momentum, the equation for conservation of energy, the advection-diffusion equation, and the wave equation.

Also, in the above embodiments, a configuration has been described in which the area of a boundary surface and the normal vector of the boundary surface are used as the boundary-surface characteristic quantities of the present embodiment.

However, the present embodiment is not limited as such; as the boundary-surface characteristic quantity, another quantity (e.g., the perimeter of the boundary surface) may be used.

Also, in the above embodiments, a configuration has been described in which a calculation data model is generated such that the six conditions described above are satisfied so as to satisfy the conservation law.

However, the present embodiment is not limited as such; if the conservation law does not need to be satisfied, the calculation data model does not necessarily need to be generated to satisfy the six conditions described above.

Also, in the above embodiments, a configuration has been described in which the volume of a divided domain is regarded as the volume of a control volume occupied by a control point arranged inside of the divided domain.

However, the present embodiment is not limited as such; a control point does not necessarily need to be arranged inside of the divided domain. In such a case, it is possible to execute numerical analysis by replacing the volume of a control volume occupied by a control point with the volume of the divided domain.

Also, in the above embodiments, the analysis domain is first divided into multiple control volumes (cells) to generate the first calculation data model, and next, the control volumes (cells) are aggregated to four aggregated domains (domains), to divide the analysis domain and to generate the second calculation data model. Then, in the solver process, calculation is executed by using the second calculation data model. However, the second calculation data model simply needs to be a calculation data model based on domains formed by aggregating cells, and may be a calculation data model that includes a new domain in which domains having cells aggregated are further aggregated.

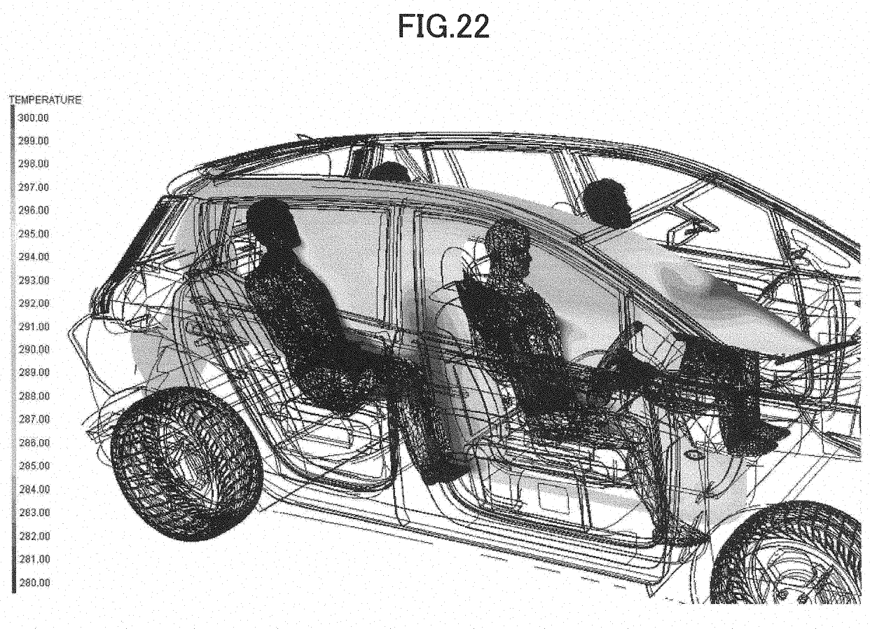

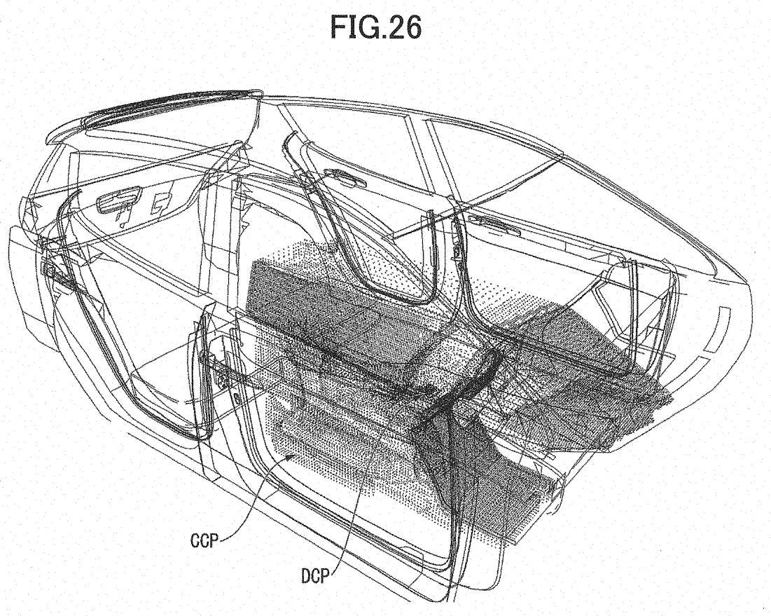

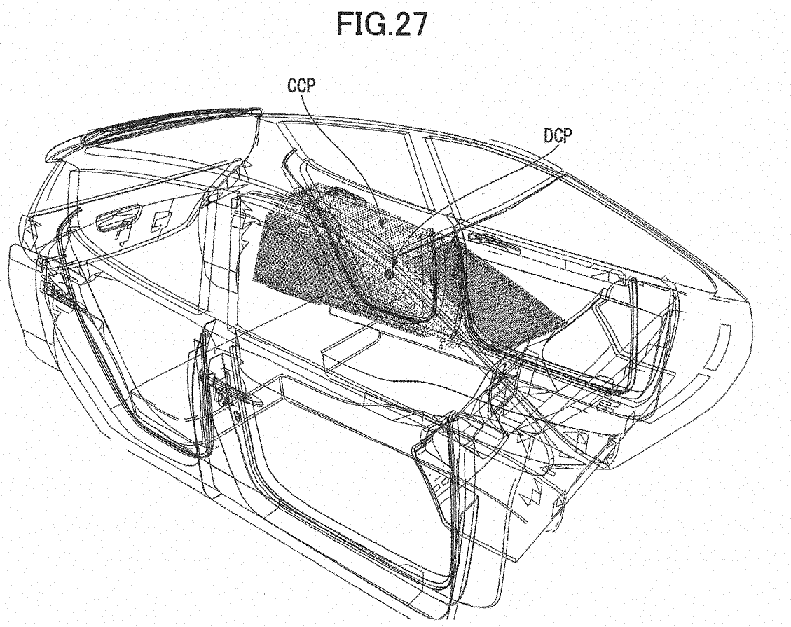

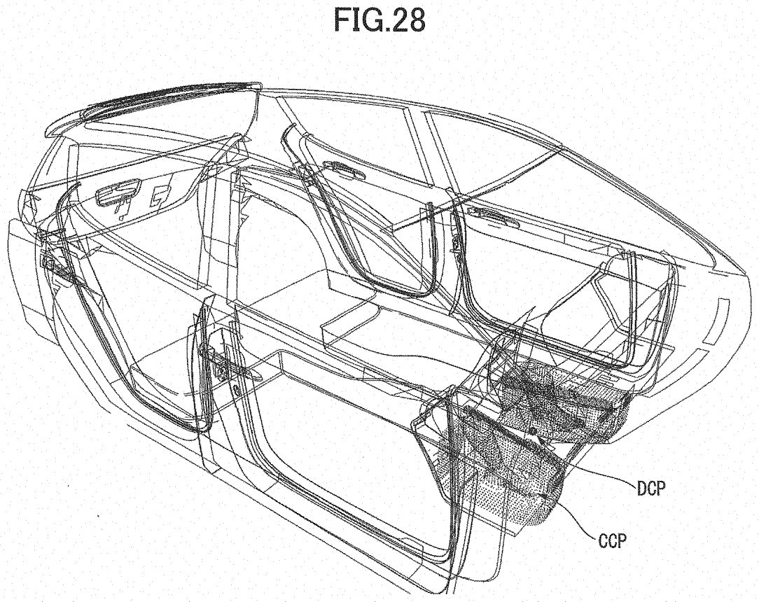

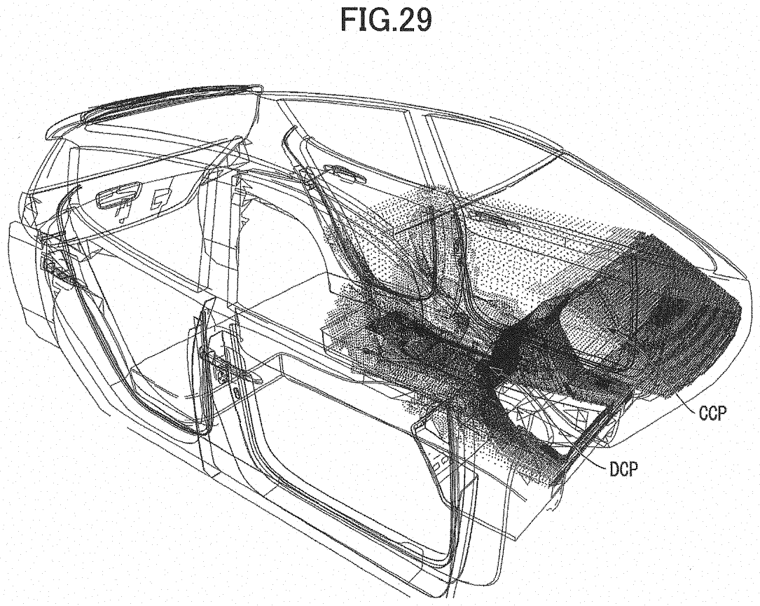

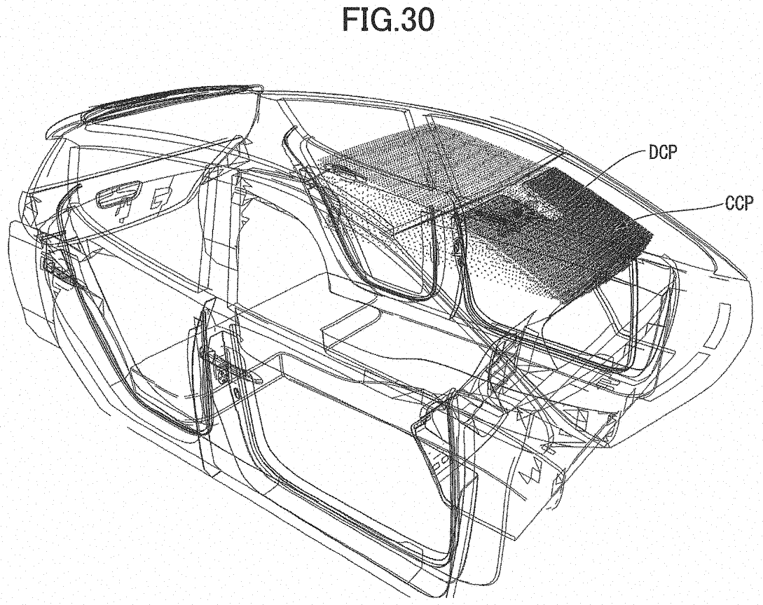

FIG. 22 to FIG. 38 are diagrams illustrating examples of results of thermal fluid simulations that were executed by using a first calculation data model (divided domains) and second calculation data models (aggregated domains) in the present embodiment.

In the present embodiment, the numerical calculation method has been described that uses the Navier-Stokes equation expressed as Equation (1) and the equation of continuum expressed as Equation (2) as the fundamental equations of fluid analysis; further, as described above, in the present embodiment, not only for the Navier-Stokes equation, but also for the advection-diffusion equation, it is possible to derive a discretized governing equation that uses only quantities that do not require quantities that specify geometrical shapes based on a weighted residual method. In execution of thermal fluid simulations illustrated in FIG. 22 to FIG. 38, as the fundamental equations of fluid analysis, in addition to the Navier-Stokes equation expressed as Equation (1) and the equation of continuum expressed as Equation (2), the heat advection-diffusion equation is used as one of the fundamental equations. As for derivation of a discretized governing equation that uses only quantities that do not require quantities that specify geometrical shapes based on a weighted residual method in the present embodiment with respect to the heat advection-diffusion equation, it is described in detail in Patent document 1, and the description is omitted here.

In the thermal fluid simulations, a cabin of a motor vehicle is taken as an example of the analysis domain, and air-conditioning conditions in summer are taken as an example of boundary conditions. Specifically, the outside-vehicle reference temperature is set to 35° C.; the outside-vehicle heat transfer rate is set to 40 W/m²K; the number of occupants in the motor vehicle is four; the wind velocity blowing out of the air conditioner is set to 5 m/s; and the air temperature blowing out of the air conditioner is set at 8° C. Note that when necessary, the analysis can be executed in a case where as the boundary conditions, at least one of the temperature of the engine room, the temperature of the trunk, the temperature of the underfloor, the temperature inside of the dashboard, the temperature of the ceiling, and other are included.

As described above, the numerical analysis apparatus A divides the analysis domain (the cabin of the motor vehicle) into cells that do not require coordinates of the vertices and connectivity information on the vertices.

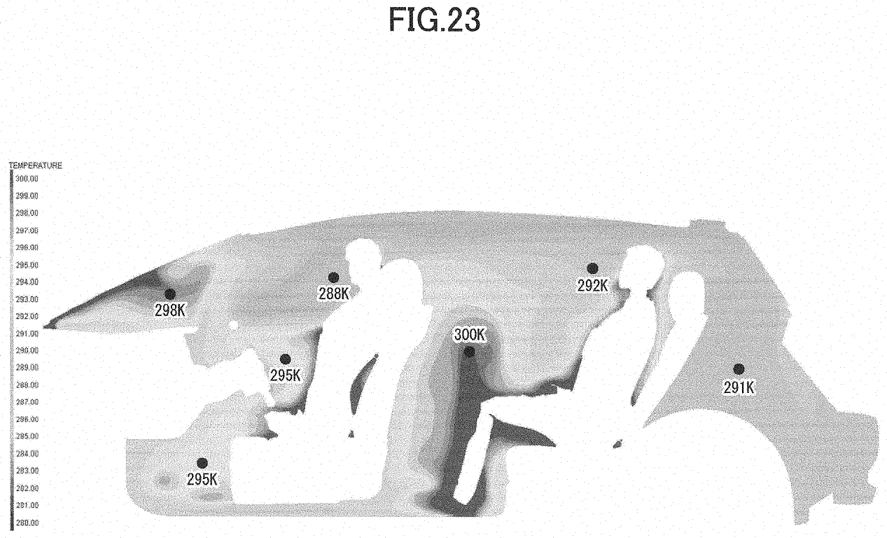

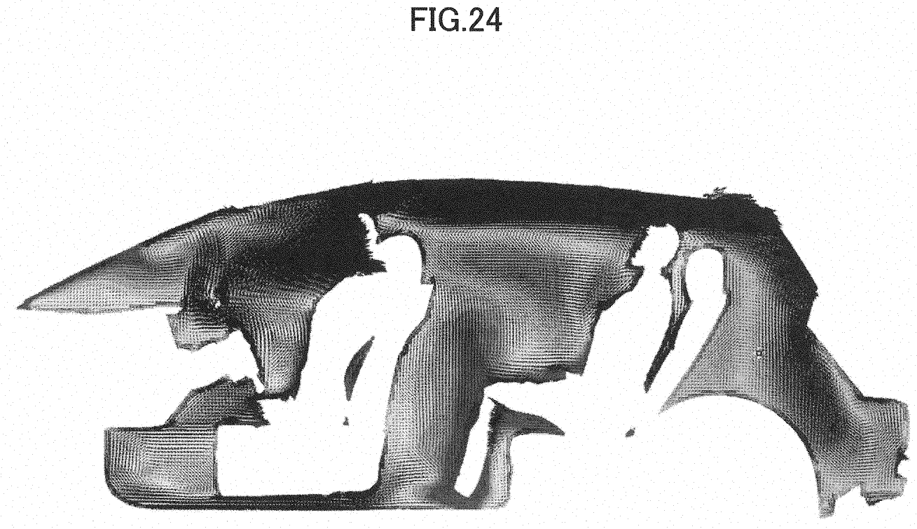

An example of a result of a three-dimensional the mal fluid simulation that was executed using a first calculation data model in which the analysis domain (the cabin of the motor vehicle) is divided into approximately 4,500,000 cells is illustrated in FIG. 22 to FIG. 24. FIG. 22 is a temperature contour diagram on a vertical cross section at the center of the driver's seat in the cabin space as the analysis domain, and FIG. 23 illustrates temperature values at seven sampling points on the vertical cross section (as the unit of temperature, K (Kelvin) is used, hereafter). Also, FIG. 24 is a flow velocity contour diagram on the vertical cross section at the center of the driver's seat in the cabin space as the analysis domain, in which the direction of the flow velocity is indicated by the direction of an arrow, and the magnitude of the flow velocity is indicated by the size of the arrow. As for the result illustrated in FIG. 22 to FIG. 24, until a calculation result of a steady state was obtained, it took approximately 30 hours of computation time by using a PC having a CPU of Xeon (2.6 GHz) made by Intel Corp. installed.

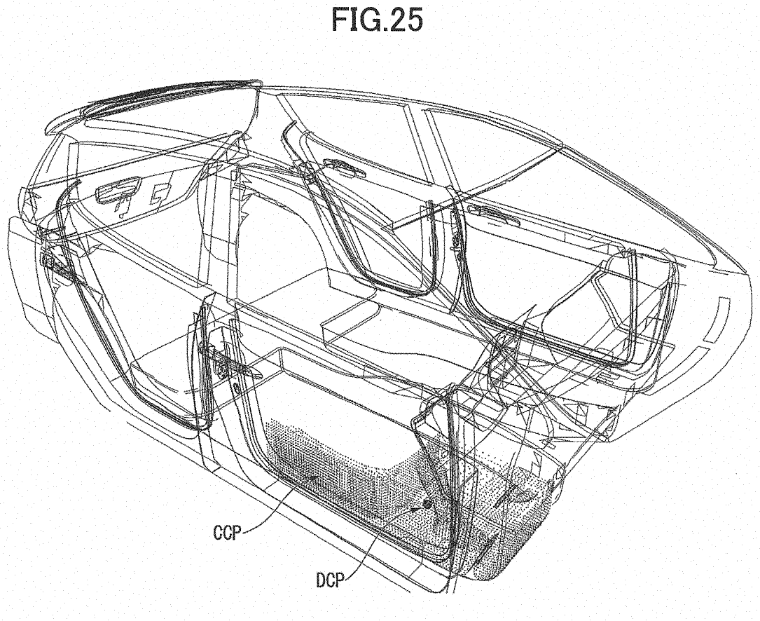

In the present embodiment, the numerical analysis apparatus A generates approximately 4,500,000 cells automatically with respect to the analysis domain (the cabin of the motor vehicle). A case will be described in which by executing the process of generating aggregated domains from cells described above, the numerical analysis apparatus A generates 27 aggregated domains (domains) from approximately 4,500,000 cells illustrated in FIG. 25 to FIG. 30. FIG. 25 to FIG. 30 illustrate an example of a result of generation of 27 aggregated domains. In each of FIG. 25 to FIG. 30, a DCP designates the control point of an aggregated domain (domain), and a CCP is one of the control points of cells. FIG. 25 to FIG. 30 illustrate a domain 1 to a domain 6 in this order. Also, although not illustrated in FIG. 25 to FIG. 30, the numerical analysis apparatus A obtains the outside surface for each of the aggregated domains. The numerical analysis apparatus A obtains a boundary condition between the obtained outside surface and a member that contacts the outside surface. The boundary condition may vary depending on the material of the member that contacts the outside surface.

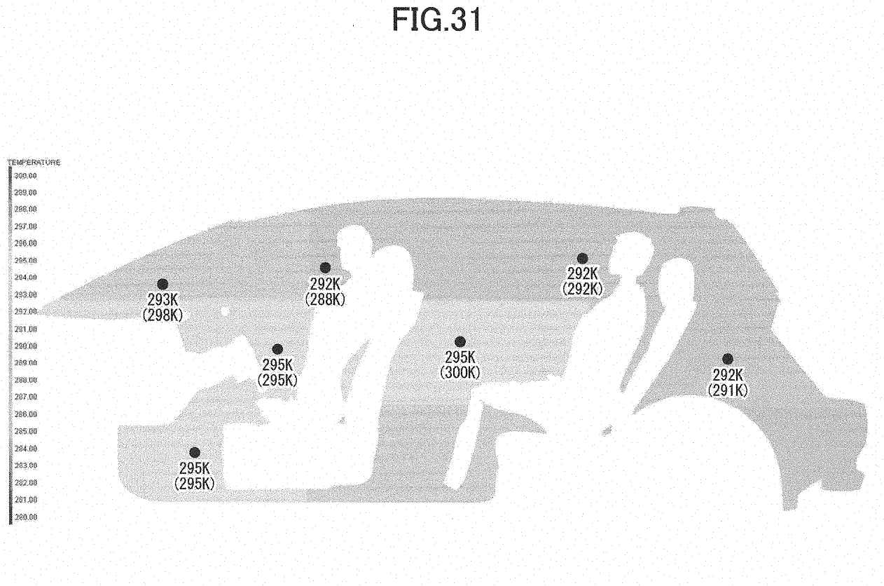

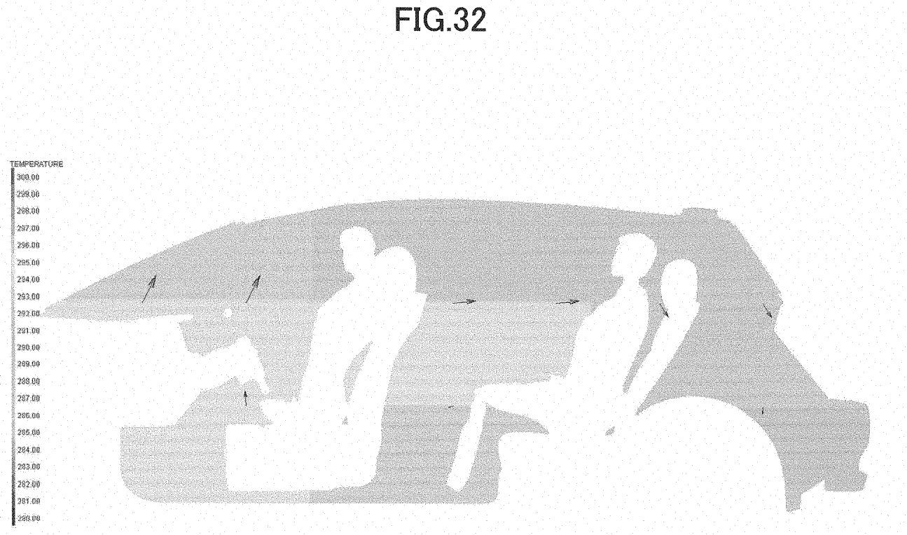

FIG. 31 and FIG. 32 illustrate an example of a result of a 3D thermal fluid simulation executed by using a second calculation data model that includes the 27 aggregated domains (domains) described above.

FIG. 31 is a temperature contour diagram on the vertical cross section at the center of the driver's seat in the cabin space as the analysis domain, which illustrates temperature values at seven sampling points on the vertical cross section. Each pair of the temperature values at the seven sampling points in FIG. 31 is separately presented with a temperature value in the upper row and a temperature value in parentheses in the lower row; the upper row presents a temperature value in the result of the 3D thermal fluid simulation executed by using the second calculation data model including the 27 aggregated domains (domains) described above, and a temperature value in parentheses in the lower row presents a temperature value in the result of the 3D thermal fluid simulation executed by using the first calculation data model divided into approximately 4,500,000 divided domains (cells) illustrated in FIG. 23. Comparing the temperature values in the upper rows with those in the lower rows, although there are some differences of the temperature values within several degrees, on the average, the values are well consistent with each other.

FIG. 32 is a temperature contour diagram on the vertical cross section at the center of the driver's seat in the cabin space as the analysis domain, and also is a diagram illustrating flow velocity vectors overlapped on the same vertical cross section. Although it can be understood that circulation flows are formed in the cabin space caused by an air flow blowing out of the air conditioner, compared with the result of the 3D thermal fluid simulation executed by using the first calculation data model divided into approximately 4,500,000 cells illustrated in FIG. 24, it can be understood that in FIG. 32, a detailed distribution of the flow in the cabin space was not calculated.

In the 3D thermal fluid simulation executed by using the second calculation data model including the 27 aggregated domains (domains) illustrated in FIG. 31 and FIG. 32, until a calculation result of a steady state was obtained, it took one second or less of computation time by using a PC having a CPU of Xeon (2.6 GHz) made by Intel Corp. installed. Comparing with approximately 30 hours of computation time taken by the 3D thermal fluid simulation executed by using the first calculation data model divided into approximately 4,500,000 cells, the numerical calculation is extremely fast.

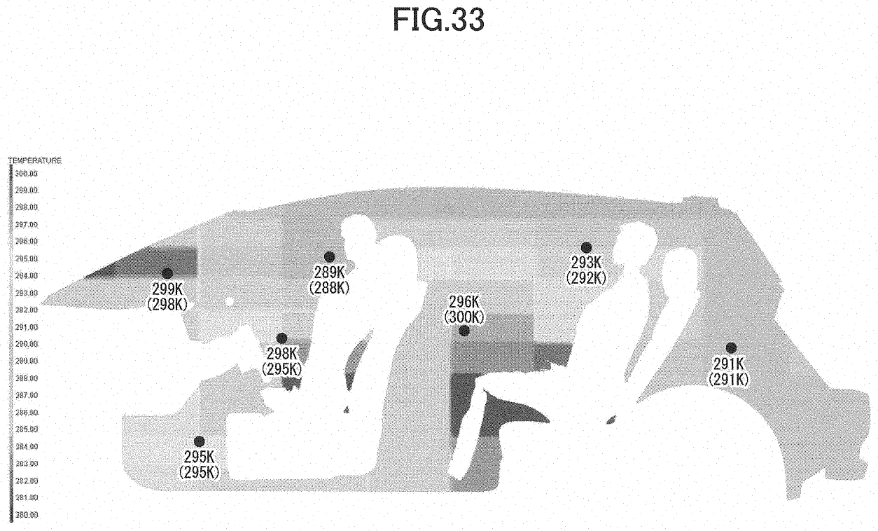

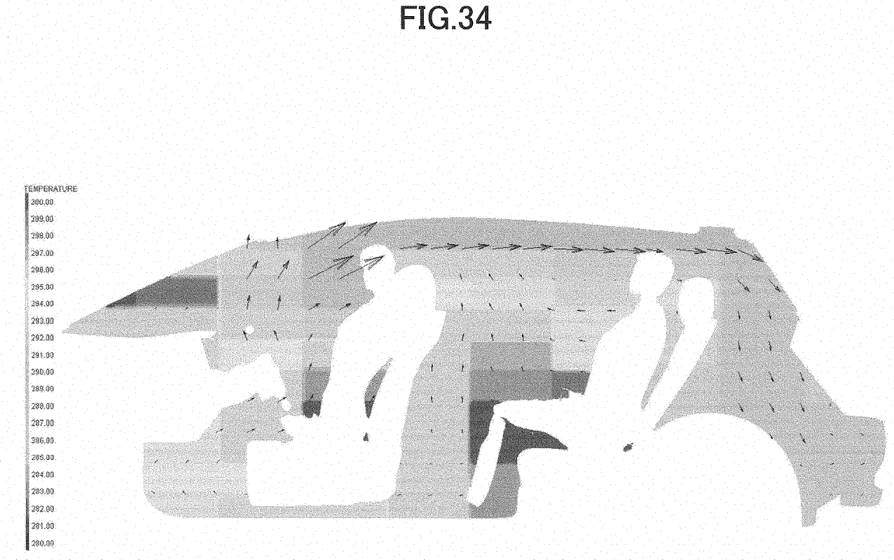

FIG. 33 and FIG. 34 illustrate an example of a result of a 3D thermal fluid simulation executed by using a second calculation data model including 792 aggregated domains (domains).

FIG. 33 is a temperature contour diagram on the vertical cross section at the center of the driver's seat in the cabin space as the analysis domain, which illustrates temperature values at seven sampling points on the vertical cross section. As in FIG. 31, each pair of the temperature values at the seven sampling points is separately presented with a temperature value in the upper row and a temperature value in parentheses in the lower row; the upper row presents a temperature value in the result of the 3D thermal fluid simulation executed by using the second calculation data model including the 792 aggregated domains (domains), and a temperature value in parentheses in the lower row presents a temperature value in the result of the 3D thermal fluid simulation executed by using the first calculation data model divided into approximately 4,500,000 divided domains (cells) illustrated in FIG. 23. Comparing the temperature values in the upper rows with those in the lower rows, although there are some differences of the temperature values within several degrees, on the average, the values are well consistent with each other.

FIG. 34 is a temperature contour diagram on the vertical cross section at the center of the driver's seat in the cabin space as the analysis domain, and also is a diagram illustrating flow velocity vectors overlapped on the same vertical cross section. It can be understood that circulation flows are formed in the cabin space caused by an air flow blowing out of the air conditioner, and compared with FIG. 32, it can be understood that details of the flows in the cabin space are improved in FIG. 34.

In the 3D thermal fluid simulation executed by using the second calculation data model including the 792 aggregated domains (domains) illustrated in FIG. 33 and FIG. 34, until a calculation result of a steady state was obtained, it took approximately 20 seconds of computation time by using a PC having a CPU of Xeon (2.6 GHz) made by Intel Corp. installed. Comparing with approximately 30 hours of computation time taken by the 3D thermal fluid simulation executed by using the first calculation data model divided into approximately 4,500,000 cells, the numerical calculation is extremely fast.

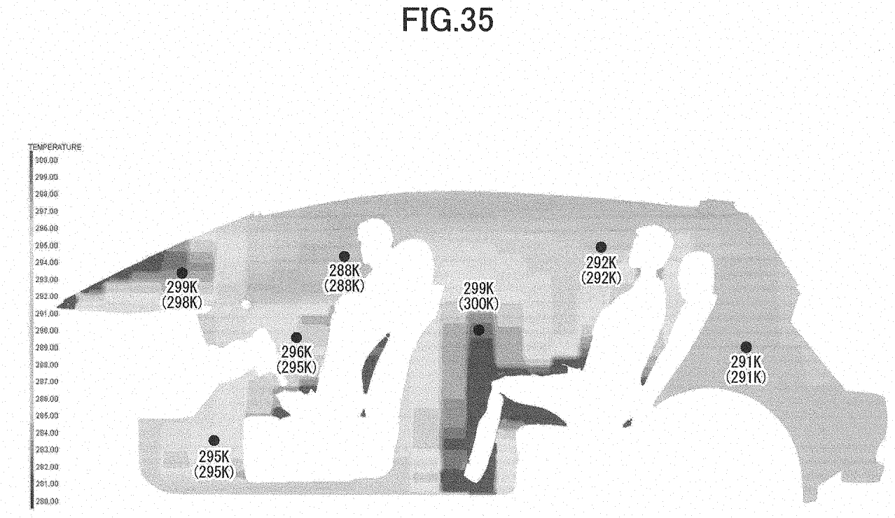

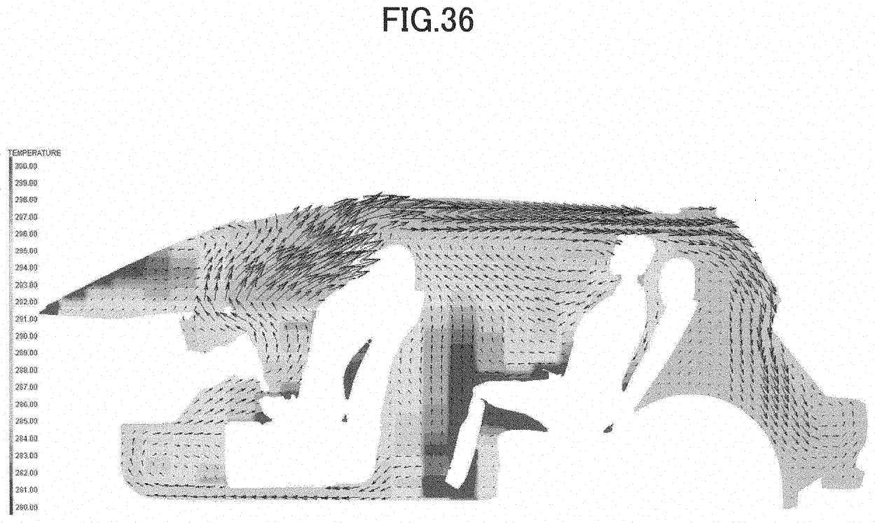

FIG. 35 and FIG. 36 illustrate an example of a result of a 3D thermal fluid simulation executed by using a second calculation data model including 16,055 aggregated domains.

FIG. 35 is a temperature contour diagram on the vertical cross section at the center of the driver's seat in the cabin space as the analysis domain, which illustrates temperature values at seven sampling points on the vertical cross section. As in FIG. 31, each pair of the temperature values at the seven sampling points is separately presented with a temperature value in the upper row and a temperature value in parentheses in the lower row; the upper row presents a temperature value in the result of the 3D thermal fluid simulation executed by using the second calculation data model including the 16,055 aggregated domains (domains), and a temperature value in parentheses in the lower row presents a temperature value in the result of the 3D thermal fluid simulation executed by using the first calculation data model divided into approximately 4,500,000 divided domains (cells) illustrated in FIG. 23. Comparing the temperature values in the upper rows with those in the lower rows, the differences of the temperature values are around one degree, and the values are very well consistent with each other.

FIG. 36 is a temperature contour diagram on the vertical cross section at the center of the driver's seat in the cabin space as the analysis domain, and also is a diagram illustrating flow velocity vectors overlapped on the same vertical cross section. It can be understood that circulation flows are formed in the cabin space caused by an air flow blowing out of the air conditioner, and compared with FIG. 32 and FIG. 34, it can be understood that the details of the flows in the cabin space are significantly improved in FIG. 36, in which local flows and vortices in the cabin space are calculated.

In the 3D thermal fluid simulation executed by using the second calculation data model including the 16,055 aggregated domains (domains) illustrated in FIG. 35 and FIG. 36, until a calculation result of a steady state was obtained, it took approximately three minutes of computation time by using a PC having a CPU of Xeon (2.6 GHz) made by Intel Corp. installed. Comparing with approximately 30 hours of computation time taken by the 3D thermal fluid simulation executed by using the first calculation data model divided into approximately 4,500,000 cells, the numerical calculation is extremely fast.

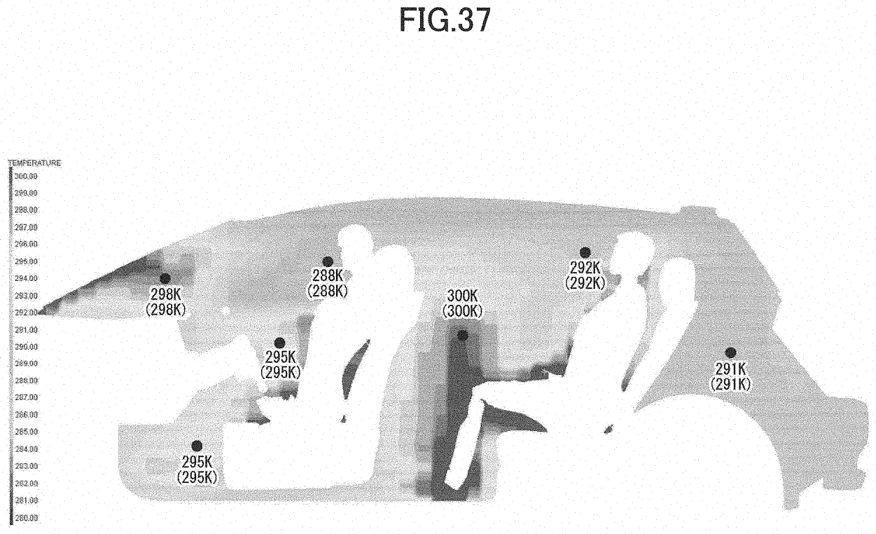

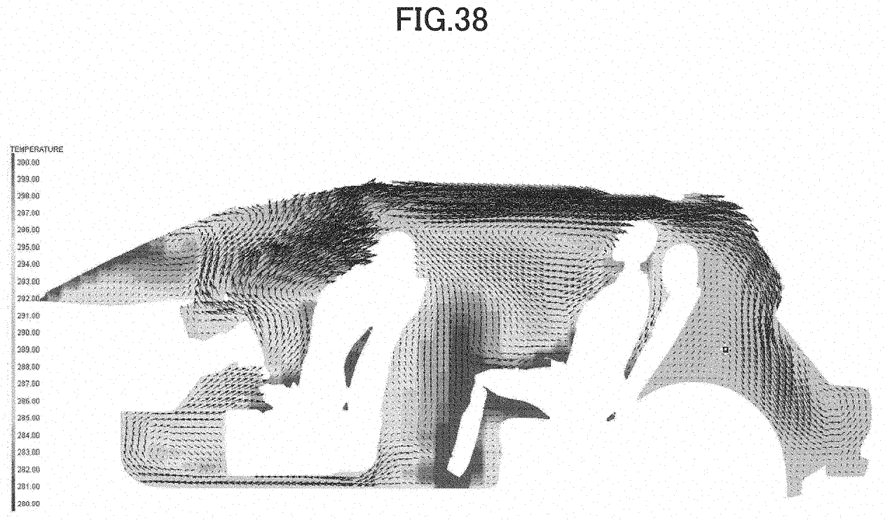

FIG. 37 and FIG. 38 illustrate an example of a result of a 3D thermal fluid simulation executed by using a second calculation data model including 66,257 aggregated domains.

FIG. 37 is a temperature contour diagram on the vertical cross section at the center of the driver's seat in the cabin space as the analysis domain, which illustrates temperature values at seven sampling points on the vertical cross section. As in FIG. 31, each pair of the temperature values at the seven sampling points is separately presented with a temperature value in the upper row and a temperature value in parentheses in the lower row; the upper row presents a temperature value in the result of the 3D thermal fluid simulation executed by using the second calculation data model including the 66,257 aggregated domains (domains), and a temperature value in parentheses in the lower row presents a temperature value in the result of the 3D thermal fluid simulation executed by using the first calculation data model divided into approximately 4,500,000 divided domains (cells) illustrated in FIG. 23. Comparing the temperature values in the upper rows with those in the lower rows, the difference of the temperature values is zero, and the values are very well consistent with each other.

FIG. 38 is a temperature contour diagram on the vertical cross section at the center of the driver's seat in the cabin space as the analysis domain, and also is a diagram illustrating flow velocity vectors overlapped on the same vertical cross section. It can be understood that circulation flows are formed in the cabin space caused by an air flow blowing out of the air conditioner, and compared with FIG. 32 and FIG. 34, it can be understood that the details of the flows in the cabin space are significantly improved in FIG. 38, in which local flows and vortices in the cabin space are calculated. Further, comparing with the result of the 3D thermal fluid simulation executed by using the first calculation data model divided into approximately 4,500,000 divided domains (cells) illustrated in FIG. 24, there is virtually no difference in precision.

In the 3D thermal fluid simulation executed by using the second calculation data model including the 66,257 aggregated domains (domains) illustrated in FIG. 37 and FIG. 38, until a calculation result of a steady state was obtained, it took approximately 12 minutes of computation time by using a PC having a CPU of Xeon (2.6 GHz) made by Intel Corp. installed. Comparing with approximately 30 hours of computation time taken by the 3D thermal fluid simulation executed by using the first calculation data model divided into approximately 4,500,000 cells, the numerical calculation is extremely fast.

As described above, examples of the results of the 3D thermal fluid simulations executed by using the second calculation data models where the numbers of the aggregated domains (domains) were 27, 792, 16,055, and 66,257 aggregated domains (domains) have been presented. Also, the precision of the results of the 3D thermal fluid simulations executed by using the second calculation data models has been presented in comparison with the result of the 3D thermal fluid simulation executed by using the first calculation data model divided into approximately 4,500,000 cells. Furthermore, it has been presented that the 3D thermal fluid simulations executed by using the second calculation data models were very fast compared with the calculation speed of the 3D thermal fluid simulation executed by using the first calculation data model. It has been also presented that depending on the object of analysis or the required precision, by selecting the number of aggregated domains (domains) appropriately, it is possible to obtain an analysis result very fast compared with a calculation that uses only cells corresponding to those in Patent document 1.

Also, in the above embodiments, a configuration has been described in which the numerical analysis program P is stored in the DVD medium X so as to be conveyable.

However, the present embodiment is not limited as such; another configuration can also be adopted in which the numerical analysis program P is stored in another removable medium so as to be conveyable.

Also, the preprocess program P1 and the solver process program P2 may be stored in separate removable media so as to be conveyable. Also, the numerical analysis program P may also be transferred through a network.

Note that the present embodiment may be used for thermal analysis of a cabin of a motor vehicle in which the simulation model reflects the shape of the body of the motor vehicle; the energy consumption in heating ventilation and air conditioning (HVAC); existence of glasses and persons; external insolation energy; humidity; the vehicle speed; and the like.

Also, other than the thermal analysis of a cabin of a motor vehicle, the present embodiment may be used for combustion analysis of an engine of a motor vehicle, analysis of the exhaust efficiency of combustion gas of a motor vehicle, thermal analysis of an engine room of a motor vehicle, and the like.

Also, the present embodiment may be used for thermal analysis in the fields other than motor vehicles. For example, the present embodiment may be used for thermal analysis of an interior space, such as a cabin or cockpit, of an aircraft, vessel, spacecraft, or the like. Also, for example, it may be used for thermal analysis of an interior space of a residence, building, atrium, or the like. Also, for example, it may be used for thermal analysis of an electric device or an industrial device. Also, for example, it may be used for thermal analysis of a device itself of a production facility of glass, steel, and the like, and may be used for thermal analysis around the device of the production facility.

Note that the first calculation data model is an example of a calculation data model with respect to divided domains. Also, the second calculation data model is an example of a calculation data model with respect to aggregated domains. Also, the boundary-surface characteristic quantity of a divided domain is an example of a divided-domain characteristic quantity. Also, the boundary-surface characteristic quantity of an aggregated domain is an example of an aggregated-domain characteristic quantity. Also, the first normal vector is an example of a normal vector of a boundary surface of a divided domain. Also, the second normal vector is an example of a normal vector of a boundary surface of an aggregated domain. Note that a physical quantity and the flow velocity of air calculated from discretized governing equations derived based on a weighted residual method, and the volumes and boundary-surface characteristic quantities of aggregated domains are examples of physical quantities as an analysis result. Note that the numerical analysis method is an example of a simulation method.

Although the present application has been described in detail and with reference to specific embodiments, it is apparent to those skilled in the art that various changes and modifications can be made without departing from the spirit and scope of the invention.

Furthermore, with respect to the embodiments described above, the following notes are further disclosed.

### (Note 1)

A simulation method executed by a computer to numerically analyze a physical quantity in a physical phenomenon, the method comprising:

obtaining by the computer three-dimensional shape data of an analysis domain from an external device;

dividing the analysis domain into a plurality of divided domains;

generating a calculation data model with respect to the divided domains based on a discretized governing equation with respect to the divided domains that uses only quantities that do not require coordinates of vertices of the divided domains and connectivity information on the vertices, wherein the discretized governing equation is derived based on a weighted residual method, and the calculation data model includes a volume of each divided domain and a divided-domain characteristic quantity representing a characteristic quantity of said each divided domain with respect to each adjacent divided domain as the quantities that do not require the coordinates of the vertices of the divided domains and the connectivity information on the vertices;

generating a requested number of aggregated domains by aggregating the divided domains;

generating a calculation data model with respect to the aggregated domains based on a discretized governing equation with respect to the aggregated domains that uses only quantities that do not require coordinates of vertices of the aggregated domains and connectivity information on the vertices, wherein the discretized governing equation is derived based on a weighted residual method, and the calculation data model includes a volume of each aggregated domain and an aggregated-domain characteristic quantity representing a characteristic quantity of said each aggregated domain with respect to each adjacent aggregated domain as the quantities that do not require the coordinates of the vertices of the aggregated domains and the connectivity information on the vertices;

calculating the physical quantity as an analysis result with respect to the aggregated domains, based on a physical property in the analysis domain and the calculation data model with respect to the aggregated domains;

generating visualized data of the physical quantity as the analysis result; and

displaying the visualized data on an output device; and

repeating when the shape of the analysis domain is changed by a user of the simulation method depending on a content displayed on the output device, starting from the three-dimensional shape data having the shape of the analysis domain changed, up to the displaying the visualized data on the output device again.

### (Note 2)

A simulation method executed by a computer to numerically analyze a physical quantity in a physical phenomenon, the method comprising:

obtaining by the computer three-dimensional shape data of an analysis domain from an external device;

dividing the analysis domain into a plurality of divided domains;

generating a calculation data model with respect to the divided domains based on a discretized governing equation with respect to the divided domains that uses only quantities that do not require coordinates of vertices of the divided domains and connectivity information on the vertices, wherein the discretized governing equation is derived based on a weighted residual method, and the calculation data model includes a volume of each divided domain and a divided-domain characteristic quantity representing a characteristic quantity of said each divided domain with respect to each adjacent divided domain as the quantities that do not require the coordinates of the vertices of the divided domains and the connectivity information on the vertices;

generating a requested number of aggregated domains by aggregating the divided domains;

generating a calculation data model with respect to the aggregated domains based on a discretized governing equation with respect to the aggregated domains that uses only quantities that do not require coordinates of vertices of the aggregated domains and connectivity information on the vertices, wherein the discretized governing equation is derived based on a weighted residual method, and the calculation data model includes a volume of each aggregated domain and an aggregated-domain characteristic quantity representing a characteristic quantity of said each aggregated domain with respect to each adjacent aggregated domain as the quantities that do not require the coordinates of the vertices of the aggregated domains and the connectivity information on the vertices;

calculating the physical quantity as an analysis result with respect to the aggregated domains, based on a physical property in the analysis domain and the calculation data model with respect to the aggregated domains;

determining, in a case where the analysis domain includes a moving boundary, whether a shape of the analysis domain changes in a time series, and in response to having determined that the shape of the analysis domain changes, repeating the generating the calculation data model with respect to the divided domains, the generating the calculation data model with respect to the aggregated domains, and the calculating the physical quantity as the analysis result with respect to the aggregated domains; and

in response to having determined that the shape of the analysis domain does not change, generating visualized data of the physical quantity as the analysis result, and displaying the visualized data on an output device.

### (Note 3)

A simulation method executed by a computer to numerically analyze a physical quantity in a physical phenomenon, the method comprising:

obtaining by the computer three-dimensional shape data of an analysis domain from an external device;

dividing the analysis domain into a plurality of divided domains;

generating a calculation data model with respect to the divided domains based on a discretized governing equation with respect to the divided domains that uses only quantities that do not require coordinates of vertices of the divided domains and connectivity information on the vertices, wherein the discretized governing equation is derived based on a weighted residual method, and the calculation data model includes a volume of each divided domain and a divided-domain characteristic quantity representing a characteristic quantity of said each divided domain with respect to each adjacent divided domain as the quantities that do not require the coordinates of the vertices of the divided domains and the connectivity information on the vertices;

generating a requested number of aggregated domains by aggregating the divided domains;

generating a calculation data model with respect to the aggregated domains based on a discretized governing equation with respect to the aggregated domains that uses only quantities that do not require coordinates of vertices of the aggregated domains and connectivity information on the vertices, wherein the discretized governing equation is derived based on a weighted residual method, and the calculation data model includes a volume of each aggregated domain and an aggregated-domain characteristic quantity representing a characteristic quantity of said each aggregated domain with respect to each adjacent aggregated domain as the quantities that do not require the coordinates of the vertices of the aggregated domains and the connectivity information on the vertices;

calculating the physical quantity as an analysis result with respect to the aggregated domains, based on a physical property in the analysis domain and the calculation data model with respect to the aggregated domains;

generating visualized data of the physical quantity as the analysis result; and

displaying the visualized data on an output device.

### (Note 4)

The method as described in any one of notes 1 to 3, wherein in the generating the calculation data model with respect to the divided domains, the divided domains are formed such that

a condition that a total sum of volumes of all the divided domains is equivalent to a volume of the analysis domain,

a condition that an area of a boundary surface is equivalent for divided domains adjacent to each other forming the boundary surface;

a condition that a normal vector of the boundary surface has an absolute value that is equivalent in either case of viewing from one of the divided domains adjacent to each other forming the boundary surface, or of viewing from another of the divided domains adjacent to each other; and

a condition that a following Equation (1) is satisfied,

$${\sum }_{i = 1}^{m} [ ( {n}_{i} \cdot {n}_{p} ) \cdot {S}_{i} ] = 0 \qquad ( 1 )$$

where [n]ₚ represents a unit normal vector of an infinitely large projection plane P that passes through a divided domain, the unit normal vector being directed in an arbitrary direction; Sᵢ represents an area of a boundary surface of the divided domain; [n]ᵢ represents a unit normal vector of the boundary surface; m represents a total number of boundary surfaces of the divided domain; and a boldface character parenthesized in [ ] represents a vector,

are satisfied.

### (Note 5)

The method as described in any one of notes 1 to 4, wherein in the generating the calculation data model with respect to the aggregated domains, the aggregated domains are formed such that

a condition that a total sum of volumes of all the aggregated domains is equivalent to a volume of the analysis domain,

a condition that an area of a boundary surface is equivalent for aggregated domains adjacent to each other forming the boundary surface;

a condition that a normal vector of the boundary surface has an absolute value that is equivalent in either case of viewing from one of the aggregated domains adjacent to each other forming the boundary surface, or of viewing from another of the aggregated domains adjacent to each other; and

a condition that a following equation (2) is satisfied,

$${\sum }_{i = 1}^{M} [ ( {N}_{i} \cdot {N}_{p} ) \cdot {Q}_{i} ] = 0 \qquad ( 2 )$$

where [N]ₚ represents a unit normal vector of an infinitely large projection plane P that passes through an aggregated domain, the unit normal vector being directed in an arbitrary direction; Qᵢ represents an area of a boundary surface of the aggregated domain; [N]ᵢ represents a unit normal vector of the boundary surface; M represents a total number of boundary surfaces of the aggregated domain; and a boldface character parenthesized in [ ] represents a vector,

are satisfied.

### (Note 6)

The method as described in any one of notes 1 to 5, wherein the divided-domain characteristic quantity includes a boundary-surface characteristic quantity that represents a characteristic of a boundary surface of divided domains adjacent to each other; linkage information on the divided domains adjacent to each other; and a distance between the divided domains adjacent to each other, and

wherein the aggregated-domain characteristic quantity includes a boundary-surface characteristic quantity that represents a characteristic of a boundary surface of aggregated domains adjacent to each other; linkage information on the aggregated domains adjacent to each other; and a distance between the aggregated domains adjacent to each other.

### (Note 7)

The method as described in note 6, wherein the boundary-surface characteristic quantity that represents the characteristic of the boundary surface of the divided domains adjacent to each other includes an area of the boundary surface of the divided domains adjacent to each other and a normal vector of the boundary surface, and

wherein the boundary-surface characteristic quantity that represents the characteristic of the boundary surface of the aggregated domains adjacent to each other includes an area of the boundary surface of the aggregated domains adjacent to each other and a normal vector of the boundary surface.

### (Note 8)

The method as described in any one of notes 1 to 7, wherein in the generating the calculation data model with respect to the divided domains, the volume of said each divided domain and the divided-domain characteristic quantity representing the characteristic quantity of said each divided domain with respect to said each adjacent divided domain are obtained from the coordinates of the vertices of the divided domains and the connectivity information on the vertices.

### (Note 9)

A program for calculating a physical quantity that causes a computer to execute a process comprising:

obtaining by the computer three-dimensional shape data of an analysis domain from an external device;

dividing the analysis domain into a plurality of divided domains;

generating a calculation data model with respect to the divided domains based on a discretized governing equation with respect to the divided domains that uses only quantities that do not require coordinates of vertices of the divided domains and connectivity information on the vertices, wherein the discretized governing equation is derived based on a weighted residual method, and the calculation data model includes a volume of each divided domain and a divided-domain characteristic quantity representing a characteristic quantity of said each divided domain with respect to each adjacent divided domain as the quantities that do not require the coordinates of the vertices of the divided domains and the connectivity information on the vertices;

generating a requested number of aggregated domains by aggregating the divided domains;

generating a calculation data model with respect to the aggregated domains based on a discretized governing equation with respect to the aggregated domains that uses only quantities that do not require coordinates of vertices of the aggregated domains and connectivity information on the vertices, wherein the discretized governing equation is derived based on a weighted residual method, and the calculation data model includes a volume of each aggregated domain and an aggregated-domain characteristic quantity representing a characteristic quantity of said each aggregated domain with respect to each adjacent aggregated domain as the quantities that do not require the coordinates of the vertices of the aggregated domains and the connectivity information on the vertices; and

calculating the physical quantity as an analysis result with respect to the aggregated domains, based on a physical property in the analysis domain and the calculation data model with respect to the aggregated domains.

### (Note 10)

A physical quantity calculation apparatus to numerically analyze a physical quantity in a physical phenomenon, comprising:

an output device configured to display data;

a communication device configured to exchange data with an external device;

an arithmetic/logic unit configured to execute
obtaining three-dimensional shape data of an analysis domain from the external device via the communication device,
dividing the analysis domain into a plurality of divided domains, and
generating a requested number of aggregated domains by aggregating the divided domains; and

a storage configured to store
a discretized governing equation with respect to the divided domains that uses only quantities that do not require coordinates of vertices of the divided domains and connectivity information on the vertices, and is derived based on a weighted residual method, and
a discretized governing equation with respect to the aggregated domains that uses only quantities that do not require coordinates of vertices of the aggregated domains and connectivity infoiivation on the vertices, and is derived based on a weighted residual method,

wherein the arithmetic/logic unit
generates a calculation data model with respect to the divided domains based on the discretized governing equation with respect to the divided domains stored in the storage, the calculation data model including a volume of each divided domain and a divided-domain characteristic quantity representing a characteristic quantity of said each divided domain with respect to each adjacent divided domain as the quantities that do not require the coordinates of the vertices of the divided domains and the connectivity information on the vertices,
generates a calculation data model with respect to the aggregated domains based on the discretized governing equation with respect to the aggregated domains stored in the storage, the calculation data model including a volume of each aggregated domain and an aggregated-domain characteristic quantity representing a characteristic quantity of said each aggregated domain with respect to each adjacent aggregated domain as the quantities that do not require the coordinates of the vertices of the aggregated domains and the connectivity information on the vertices,
calculates the physical quantity as an analysis result with respect to the aggregated domains, based on a physical property in the analysis domain and the calculation data model with respect to the aggregated domains,
generates visualized data of the physical quantity as the analysis result, and
displays the visualized data on the output device.

1. A simulation method executed by a computer to numerically analyze a physical quantity in a physical phenomenon, the method comprising:
obtaining by the computer three-dimensional shape data of an analysis domain from an external device;
dividing the analysis domain into a plurality of divided domains;
generating a calculation data model with respect to the divided domains based on a discretized governing equation with respect to the divided domains that uses only quantities that do not require coordinates of vertices of the divided domains and connectivity information on the vertices, wherein the discretized governing equation is derived based on a weighted residual method, and the calculation data model includes a volume of each divided domain and a divided-domain characteristic quantity representing a characteristic quantity of said each divided domain with respect to each adjacent divided domain as the quantities that do not require the coordinates of the vertices of the divided domains and the connectivity information on the vertices;
generating a requested number of aggregated domains by aggregating the divided domains;
generating a calculation data model with respect to the aggregated domains based on a discretized governing equation with respect to the aggregated domains that uses only quantities that do not require coordinates of vertices of the aggregated domains and connectivity information on the vertices, wherein the discretized governing equation is derived based on a weighted residual method, and the calculation data model includes a volume of each aggregated domain and an aggregated-domain characteristic quantity representing a characteristic quantity of said each aggregated domain with respect to each adjacent aggregated domain as the quantities that do not require the coordinates of the vertices of the aggregated domains and the connectivity information on the vertices;
calculating the physical quantity as an analysis result with respect to the aggregated domains, based on a physical property in the analysis domain and the calculation data model with respect to the aggregated domains;
generating visualized data of the physical quantity as the analysis result; and
displaying the visualized data on an output device.

2. The method as claimed in claim 1, wherein in the generating the calculation data model with respect to the divided domains, the divided domains are formed such that
a condition that a total sum of volumes of all the divided domains is equivalent to a volume of the analysis domain,
a condition that an area of a boundary surface is equivalent for divided domains adjacent to each other forming the boundary surface;
a condition that a normal vector of the boundary surface has an absolute value that is equivalent in either case of viewing from one of the divided domains adjacent to each other forming the boundary surface, or of viewing from another of the divided domains adjacent to each other; and
a condition that a following Equation (1) is satisfied,
$${\sum }_{i = 1}^{m} [ ( {n}_{i} \cdot {n}_{p} ) \cdot {S}_{i} ] = 0 \qquad ( 1 )$$
where [n]p represents a unit normal vector of an infinitely large projection plane P that passes through a divided domain, the unit normal vector being directed in an arbitrary direction; Si represents an area of a boundary surface of the divided domain; [n]i represents a unit normal vector of the boundary surface; m represents a total number of boundary surfaces of the divided domain; and a boldface character parenthesized in [ ] represents a vector,
are satisfied.

3. The method as claimed in claim 1, wherein in the generating the calculation data model with respect to the aggregated domains, the aggregated domains are formed such that
a condition that a total sum of volumes of all the aggregated domains is equivalent to a volume of the analysis domain,
a condition that an area of a boundary surface is equivalent for aggregated domains adjacent to each other forming the boundary surface;
a condition that a normal vector of the boundary surface has an absolute value that is equivalent in either case of viewing from one of the aggregated domains adjacent to each other forming the boundary surface, or of viewing from another of the aggregated domains adjacent to each other; and
a condition that a following equation (2) is satisfied,
$${\sum }_{i = 1}^{M} [ ( {N}_{i} \cdot {N}_{p} ) \cdot {Q}_{i} ] = 0 \qquad ( 2 )$$
where [N]P represents a unit normal vector of an infinitely large projection plane P that passes through an aggregated domain, the unit normal vector being directed in an arbitrary direction; Qi represents an area of a boundary surface of the aggregated domain; [N]i represents a unit normal vector of the boundary surface; M represents a total number of boundary surfaces of the aggregated domain; and a boldface character parenthesized in [ ] represents a vector,
are satisfied.

4. The method as claimed in claim 1, wherein the divided-domain characteristic quantity includes a boundary-surface characteristic quantity that represents a characteristic of a boundary surface of divided domains adjacent to each other; linkage information on the divided domains adjacent to each other; and a distance between the divided domains adjacent to each other, and
wherein the aggregated-domain characteristic quantity includes a boundary-surface characteristic quantity that represents a characteristic of a boundary surface of aggregated domains adjacent to each other; linkage information on the aggregated domains adjacent to each other; and a distance between the aggregated domains adjacent to each other.

5. The method as claimed in claim 6, wherein the boundary-surface characteristic quantity that represents the characteristic of the boundary surface of the divided domains adjacent to each other includes an area of the boundary surface of the divided domains adjacent to each other and a normal vector of the boundary surface, and
wherein the boundary-surface characteristic quantity that represents the characteristic of the boundary surface of the aggregated domains adjacent to each other includes an area of the boundary surface of the aggregated domains adjacent to each other and a normal vector of the boundary surface.

6. The method as claimed in claim 1, wherein in the generating the calculation data model with respect to the divided domains, the volume of said each divided domain and the divided-domain characteristic quantity representing the characteristic quantity of said each divided domain with respect to said each adjacent divided domain are obtained from the coordinates of the vertices of the divided domains and the connectivity information on the vertices.

7. A program for calculating a physical quantity that causes a computer to execute a process comprising:
obtaining by the computer three-dimensional shape data of an analysis domain from an external device;
dividing the analysis domain into a plurality of divided domains;
generating a calculation data model with respect to the divided domains based on a discretized governing equation with respect to the divided domains that uses only quantities that do not require coordinates of vertices of the divided domains and connectivity information on the vertices, wherein the discretized governing equation is derived based on a weighted residual method, and the calculation data model includes a volume of each divided domain and a divided-domain characteristic quantity representing a characteristic quantity of said each divided domain with respect to each adjacent divided domain as the quantities that do not require the coordinates of the vertices of the divided domains and the connectivity information on the vertices;
generating a requested number of aggregated domains by aggregating the divided domains;
generating a calculation data model with respect to the aggregated domains based on a discretized governing equation with respect to the aggregated domains that uses only quantities that do not require coordinates of vertices of the aggregated domains and connectivity information on the vertices, wherein the discretized governing equation is derived based on a weighted residual method, and the calculation data model includes a volume of each aggregated domain and an aggregated-domain characteristic quantity representing a characteristic quantity of said each aggregated domain with respect to each adjacent aggregated domain as the quantities that do not require the coordinates of the vertices of the aggregated domains and the connectivity information on the vertices; and
calculating the physical quantity as an analysis result with respect to the aggregated domains, based on a physical property in the analysis domain and the calculation data model with respect to the aggregated domains.

8. A physical quantity calculation apparatus to numerically analyze a physical quantity in a physical phenomenon, comprising:
an output device configured to display data;
a communication device configured to exchange data with an external device;
an arithmetic/logic unit configured to execute
obtaining three-dimensional shape data of an analysis domain from the external device via the communication device,
dividing the analysis domain into a plurality of divided domains, and
generating a requested number of aggregated domains by aggregating the divided domains; and
a storage configured to store
a discretized governing equation with respect to the divided domains that uses only quantities that do not require coordinates of vertices of the divided domains and connectivity information on the vertices, and is derived based on a weighted residual method, and
a discretized governing equation with respect to the aggregated domains that uses only quantities that do not require coordinates of vertices of the aggregated domains and connectivity information on the vertices, and is derived based on a weighted residual method,
wherein the arithmetic/logic unit
generates a calculation data model with respect to the divided domains based on the discretized governing equation with respect to the divided domains stored in the storage, the calculation data model including a volume of each divided domain and a divided-domain characteristic quantity representing a characteristic quantity of said each divided domain with respect to each adjacent divided domain as the quantities that do not require the coordinates of the vertices of the divided domains and the connectivity information on the vertices,
generates a calculation data model with respect to the aggregated domains based on the discretized governing equation with respect to the aggregated domains stored in the storage, the calculation data model including a volume of each aggregated domain and an aggregated-domain characteristic quantity representing a characteristic quantity of said each aggregated domain with respect to each adjacent aggregated domain as the quantities that do not require the coordinates of the vertices of the aggregated domains and the connectivity information on the vertices,
calculates the physical quantity as an analysis result with respect to the aggregated domains, based on a physical property in the analysis domain and the calculation data model with respect to the aggregated domains,
generates visualized data of the physical quantity as the analysis result, and
displays the visualized data on the output device.
